(19) United States
(12) Patent Application Publication
(10) Pub. No.: US 2023/0224696 A1
(43) Pub. Date: Jul. 13, 2023

(54) PRECODING FOR JOINT SENSING AND COMMUNICATION SERVICES

(71) Applicant: QUALCOMM Incorporated, San Diego, CA (US)

(72) Inventors: Qiaoyu LI, Beijing (CN); Hao XU, Beijing (CN); Yu ZHANG, San Diego, CA (US); Chao WEI, Beijing (CN); Jing DAI, Beijing (CN); Min HUANG, Beijing (CN)

(21) Appl. No.: 17/998,213

(22) PCT Filed: Jun. 2, 2021
(86) PCT No.: PCT/CN2021/097827

§ 371 Date: Nov. 8, 2022

(30) Foreign Application Priority Data
Jun. 30, 2020 (WO) PCTCN2020099114
Jun. 30, 2020 (WO) PCTCN2020099135

(51) Int. Cl. H04W 8/24; H04W 24/08; H04W 72/04

(52) U.S. Cl. CPC H04W 8/24; H04W 24/08; H04W 72/04

(57) ABSTRACT

Various aspects of the present disclosure generally relate to wireless communication. In some aspects, a user equipment (UE) may determine that capability information associated with the UE is to be transmitted. The capability information may indicate one or more sensing signal receiving schemes supported by the UE. The UE may transmit the capability information based at least in part on determining that the capability information is to be transmitted. Numerous other aspects are provided.

### CROSS-REFERENCE TO RELATED APPLICATION

This patent application claims priority to Patent Cooperation Treaty (PCT) Application No. PCT/CN2020/099135, filed on Jun. 30, 2020, entitled “PRECODING FOR JOINT SENSING AND COMMUNICATION SERVICES,” and assigned to the assignee hereof, and this patent application claims priority to PCT Application No. PCT/CN2020/099114, filed on Jun. 30, 2020, entitled “SENSING SIGNAL CONFIGURATION AND SCHEDULING,” and assigned to the assignee hereof. The disclosures of the prior applications are considered part of and are incorporated by reference in this patent application.

### FIELD OF THE DISCLOSURE

Aspects of the present disclosure generally relate to wireless communication and to techniques and apparatuses for precoding for joint sensing and communication services.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes: receiving a configuration or indication, to receive multiple iterations of a sensing signal via multiple slots, that indicates a precoding that is fixed for the multiple slots; and receiving the multiple iterations of the sensing signal via the multiple slots based at least in part on the precoding.

In some aspects, a method of wireless communication performed by a UE includes: receiving an indication of whether a sensing signal is transmitted using a same precoding as a previous sensing signal or a subsequent sensing signal; and determining a Doppler estimation associated with an object based at least in part on the sensing signal and the indication of whether the sensing signal is transmitted using the same precoding as the previous sensing signal or the subsequent sensing signal.

In some aspects, a method of wireless communication performed by a base station includes: transmitting a configuration or indication, for a UE to receive multiple iterations of a sensing signal via multiple slots, that indicates a precoding that is fixed for the multiple slots; and transmitting, to the UE, the multiple iterations of the sensing signal via the multiple slots based at least in part on the precoding.

In some aspects, a method of wireless communication performed by a base station includes: transmitting an indication of whether a sensing signal is transmitted to a UE using a same precoding as a previous sensing signal or a subsequent sensing signal; and receiving an indication of a Doppler estimation associated with an object based at least in part on the sensing signal and the indication of whether the sensing signal is transmitted using the same precoding as the previous sensing signal or the subsequent sensing signal.

In some aspects, a user equipment for wireless communication includes: a memory, and one or more processors coupled to the memory, the memory and the one or more processors configured to: receive a configuration or indication, to receive multiple iterations of a sensing signal via multiple slots, that indicates a precoding that is fixed for the multiple slots; and receive the multiple iterations of the sensing signal via the multiple slots based at least in part on the precoding.

In some aspects, a user equipment for wireless communication includes: a memory, and one or more processors coupled to the memory, the memory and the one or more processors configured to: receive an indication of whether a sensing signal is transmitted using a same precoding as a previous sensing signal or a subsequent sensing signal; and determine a Doppler estimation associated with an object based at least in part on the sensing signal and the indication of whether the sensing signal is transmitted using the same precoding as the previous sensing signal or the subsequent sensing signal.

In some aspects, a base station for wireless communication includes: a memory, and one or more processors coupled to the memory, the memory and the one or more processors configured to: transmit a configuration or indication, for a UE to receive multiple iterations of a sensing signal via multiple slots, that indicates a precoding that is fixed for the multiple slots; and transmit, to the UE, the multiple iterations of the sensing signal via the multiple slots based at least in part on the precoding.

In some aspects, a base station for wireless communication includes: a memory, and one or more processors coupled to the memory, the memory and the one or more processors configured to: transmit an indication of whether a sensing signal is transmitted to a UE using a same precoding as a previous sensing signal or a subsequent sensing signal; and receive an indication of a Doppler estimation associated with an object based at least in part on the sensing signal and the indication of whether the sensing signal is transmitted using the same precoding as the previous sensing signal or the subsequent sensing signal.

In some aspects, a non-transitory computer-readable medium storing one or more instructions for wireless communication includes: one or more instructions that, when executed by one or more processors of a user equipment, cause the one or more processors to: receive a configuration or indication, to receive multiple iterations of a sensing signal via multiple slots, that indicates a precoding that is fixed for the multiple slots; and receive the multiple iterations of the sensing signal via the multiple slots based at least in part on the precoding.

In some aspects, a non-transitory computer-readable medium storing one or more instructions for wireless communication includes: one or more instructions that, when executed by one or more processors of a user equipment, cause the one or more processors to: receive an indication of whether a sensing signal is transmitted using a same precoding as a previous sensing signal or a subsequent sensing signal; and determine a Doppler estimation associated with an object based at least in part on the sensing signal and the indication of whether the sensing signal is transmitted using the same precoding as the previous sensing signal or the subsequent sensing signal.

In some aspects, a non-transitory computer-readable medium storing one or more instructions for wireless communication includes: one or more instructions that, when executed by one or more processors of a base station, cause the one or more processors to: transmit a configuration or indication, for a UE to receive multiple iterations of a sensing signal via multiple slots, that indicates a precoding that is fixed for the multiple slots; and transmit, to the UE, the multiple iterations of the sensing signal via the multiple slots based at least in part on the precoding.

In some aspects, a non-transitory computer-readable medium storing one or more instructions for wireless communication includes: one or more instructions that, when executed by one or more processors of a base station, cause the one or more processors to: transmit an indication of whether a sensing signal is transmitted to a UE using a same precoding as a previous sensing signal or a subsequent sensing signal; and receive an indication of a Doppler estimation associated with an object based at least in part on the sensing signal and the indication of whether the sensing signal is transmitted using the same precoding as the previous sensing signal or the subsequent sensing signal.

In some aspects, an apparatus for wireless communication includes: means for receiving a configuration or indication, to receive multiple iterations of a sensing signal via multiple slots, that indicates a precoding that is fixed for the multiple slots; and means for receiving the multiple iterations of the sensing signal via the multiple slots based at least in part on the precoding.

In some aspects, an apparatus for wireless communication includes: means for receiving an indication of whether a sensing signal is transmitted using a same precoding as a previous sensing signal or a subsequent sensing signal; and means for determining a Doppler estimation associated with an object based at least in part on the sensing signal and the indication of whether the sensing signal is transmitted using the same precoding as the previous sensing signal or the subsequent sensing signal.

In some aspects, an apparatus for wireless communication includes: means for transmitting a configuration or indication, for a UE to receive multiple iterations of a sensing signal via multiple slots, that indicates a precoding that is fixed for the multiple slots; and means for transmitting, to the UE, the multiple iterations of the sensing signal via the multiple slots based at least in part on the precoding.

In some aspects, an apparatus for wireless communication includes: means for transmitting an indication of whether a sensing signal is transmitted to a UE using a same precoding as a previous sensing signal or a subsequent sensing signal; and means for receiving an indication of a Doppler estimation associated with an object based at least in part on the sensing signal and the indication of whether the sensing signal is transmitted using the same precoding as the previous sensing signal or the subsequent sensing signal.

In some aspects, a method of wireless communication performed by a UE includes: determining that capability information associated with the UE is to be transmitted, the capability information indicating one or more sensing signal receiving schemes supported by the UE; and transmitting the capability information based at least in part on determining that the capability information is to be transmitted.

In some aspects, a method of wireless communication performed by a UE includes: determining a set of parameters for a signal to be received by the UE, wherein the signal is to be used by the UE for object detection or for identification of communication interference, and wherein the set of parameters includes information associated with a waveform for the signal; and receiving the signal based at least in part on the set of parameters.

In some aspects, a method of wireless communication performed by a base station includes: determining a set of parameters for a signal to be transmitted by the base station, wherein the signal is to be used for object detection, and wherein the set of parameters includes information associated with a waveform for the signal; and transmitting the signal based at least in part on the set of parameters.

In some aspects, a UE for wireless communication includes: a memory, and one or more processors coupled to the memory, the memory and the one or more processors configured to: determine that capability information associated with the UE is to be transmitted, the capability information indicating one or more sensing signal receiving schemes supported by the UE; and transmit the capability information based at least in part on determining that the capability information is to be transmitted.

In some aspects, a UE for wireless communication includes: a memory, and one or more processors coupled to the memory, the memory and the one or more processors configured to: determine a set of parameters for a signal to be received by the UE, wherein the signal is to be used by the UE for object detection or for identification of communication interference, and wherein the set of parameters includes information associated with a waveform for the signal; and receive the signal based at least in part on the set of parameters.

In some aspects, a base station for wireless communication includes: a memory, and one or more processors coupled to the memory, the memory and the one or more processors configured to: determine a set of parameters for a signal to be transmitted by the base station, wherein the signal is to be used for object detection, and wherein the set of parameters includes information associated with a waveform for the signal; and transmit the signal based at least in part on the set of parameters.

In some aspects, a non-transitory computer-readable medium storing one or more instructions for wireless communication includes: one or more instructions that, when executed by one or more processors of a UE, cause the one or more processors to: determine that capability information associated with the UE is to be transmitted, the capability information indicating one or more sensing signal receiving schemes supported by the UE; and transmit the capability information based at least in part on determining that the capability information is to be transmitted.

In some aspects, a non-transitory computer-readable medium storing one or more instructions for wireless communication includes: one or more instructions that, when executed by one or more processors of a UE, cause the one or more processors to: determine a set of parameters for a signal to be received by the UE, wherein the signal is to be used by the UE for object detection or for identification of communication interference, and wherein the set of parameters includes information associated with a waveform for the signal; and receive the signal based at least in part on the set of parameters.

In some aspects, a non-transitory computer-readable medium storing one or more instructions for wireless communication includes: one or more instructions that, when executed by one or more processors of a base station, cause the one or more processors to: determine a set of parameters for a signal to be transmitted by the base station, wherein the signal is to be used for object detection, and wherein the set of parameters includes information associated with a waveform for the signal; and transmit the signal based at least in part on the set of parameters.

In some aspects, an apparatus for wireless communication includes: means for determining that capability information associated with the apparatus is to be transmitted, the capability information indicating one or more sensing signal receiving schemes supported by the apparatus; and means for transmitting the capability information based at least in part on determining that the capability information is to be transmitted.

In some aspects, an apparatus for wireless communication includes: means for determining a set of parameters for a signal to be received by the apparatus, wherein the signal is to be used by the apparatus for object detection or for identification of communication interference, and wherein the set of parameters includes information associated with a waveform for the signal; and means for receiving the signal based at least in part on the set of parameters.

In some aspects, an apparatus for wireless communication includes: means for determining a set of parameters for a signal to be transmitted by the apparatus, wherein the signal is to be used for object detection, and wherein the set of parameters includes information associated with a waveform for the signal; and means for transmitting the signal based at least in part on the set of parameters.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, RF chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a UE in a wireless network, in accordance with the present disclosure.

FIG. 3 is a diagram illustrating an example of space division multiplexing sensing signals and communication signals, in accordance with the present disclosure.

FIGS. 4-6 are diagrams illustrating examples associated with precoding for joint sensing and communication services, in accordance with the present disclosure.

FIGS. 7-10 are diagrams illustrating example processes associated with precoding for joint sensing and communication services, in accordance with the present disclosure.

FIGS. 11-13 are diagrams illustrating examples associated with sensing signal configuration and scheduling, in accordance with the present disclosure.

FIGS. 14-16 are diagrams illustrating example processes associated with sensing signal configuration and scheduling, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

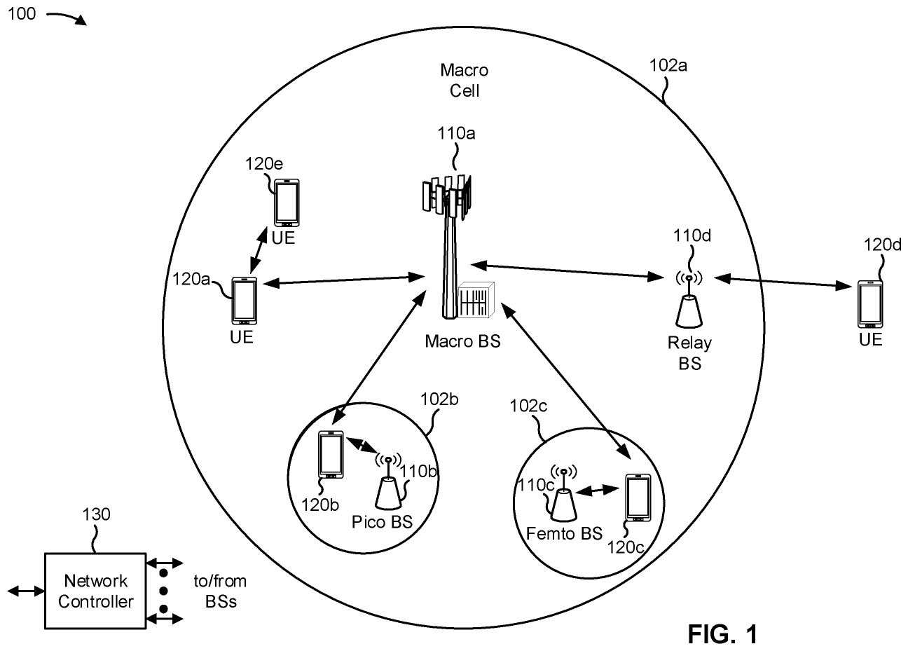

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, directly or indirectly, via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

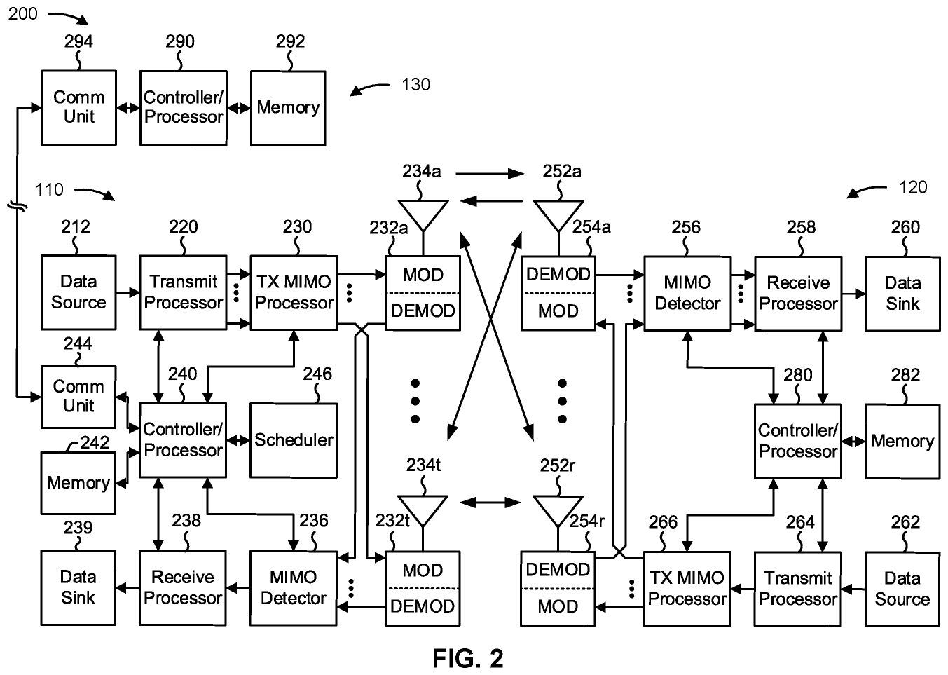

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

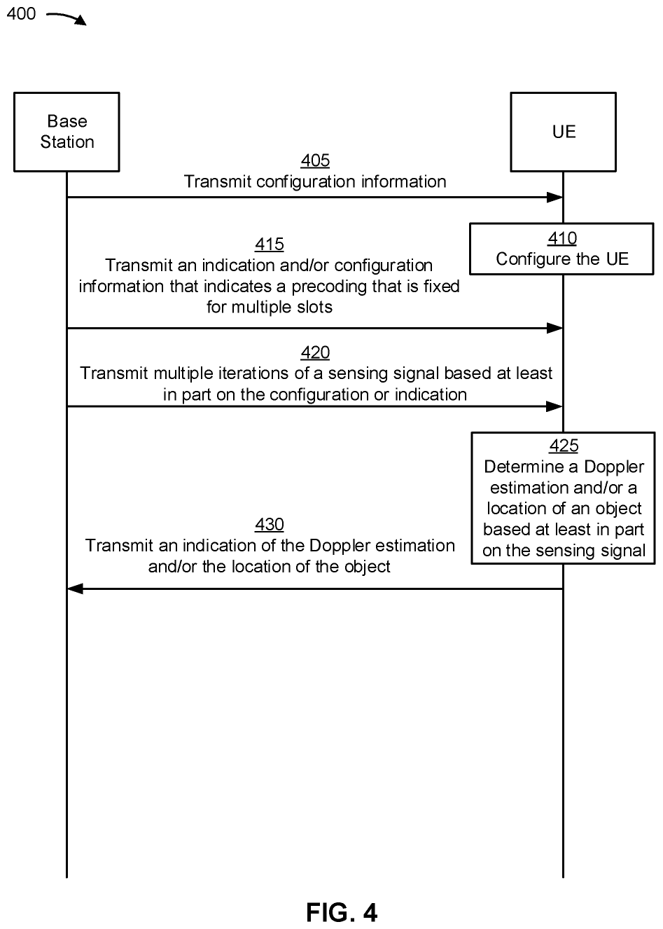

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 4-16).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 4-16).

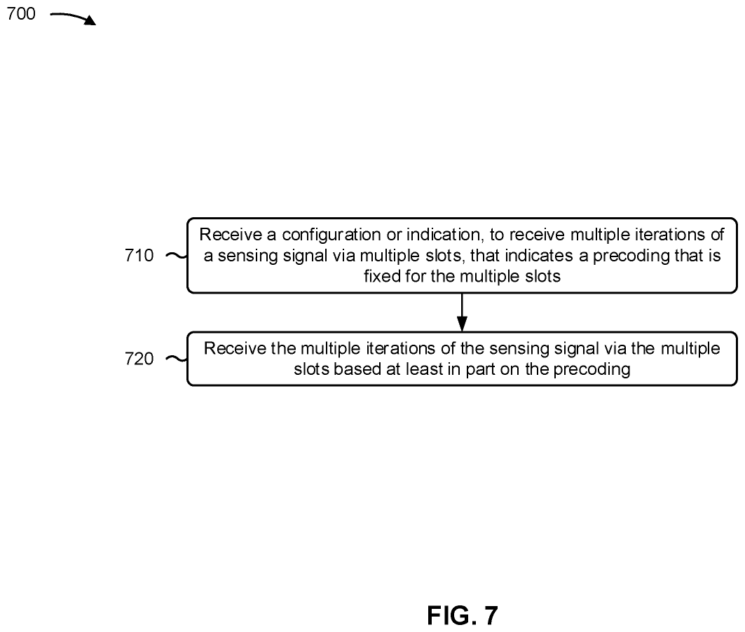

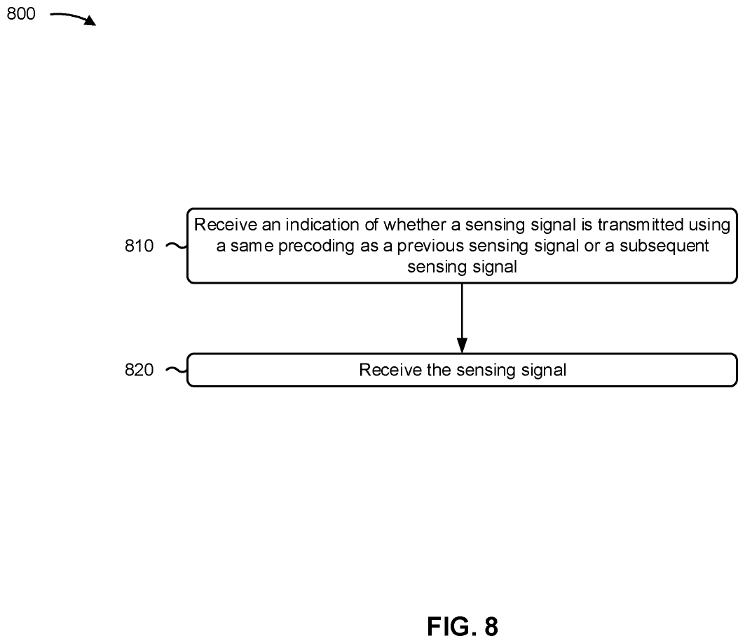

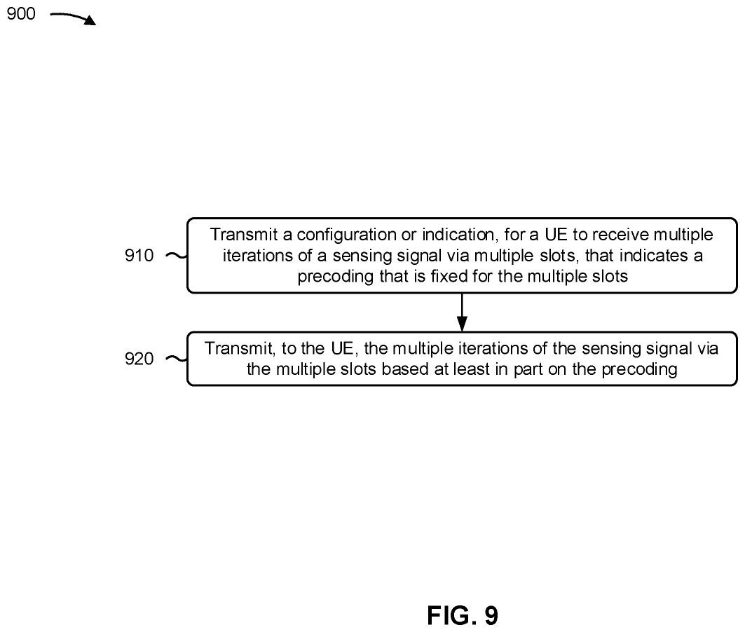

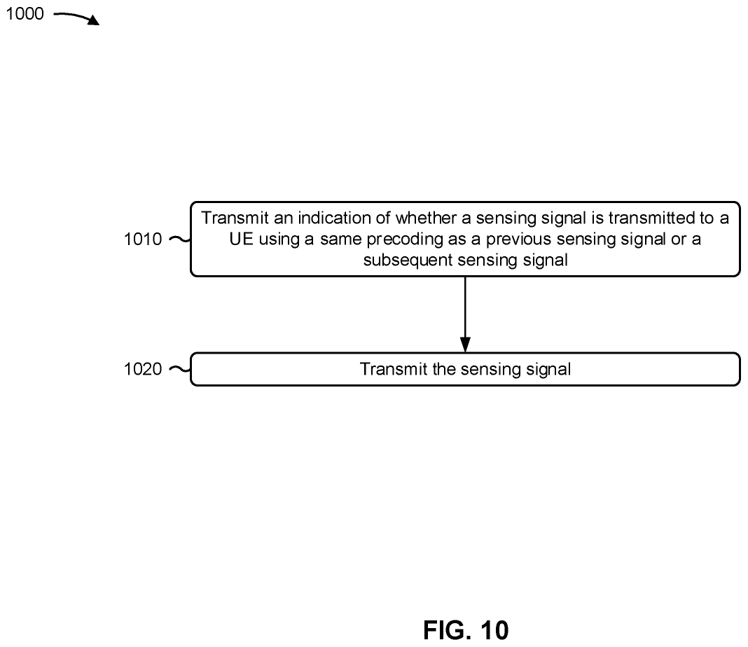

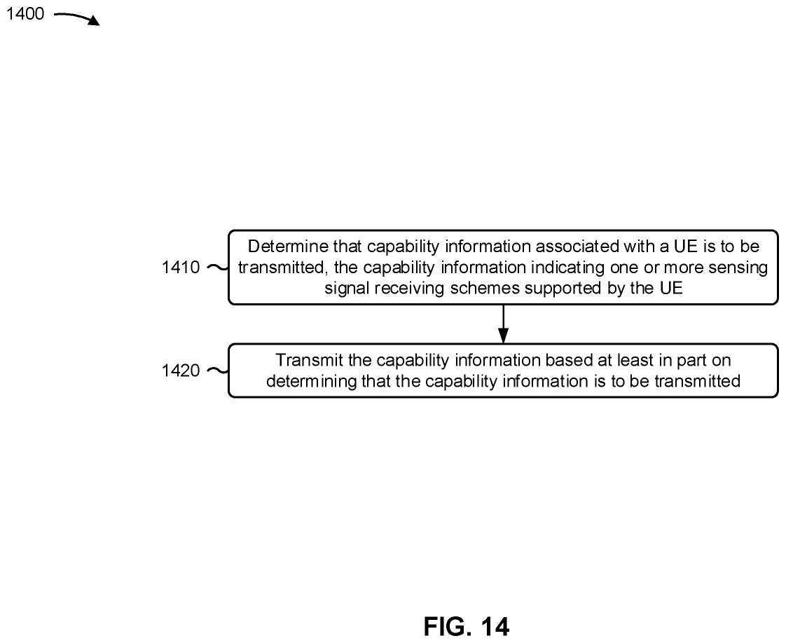

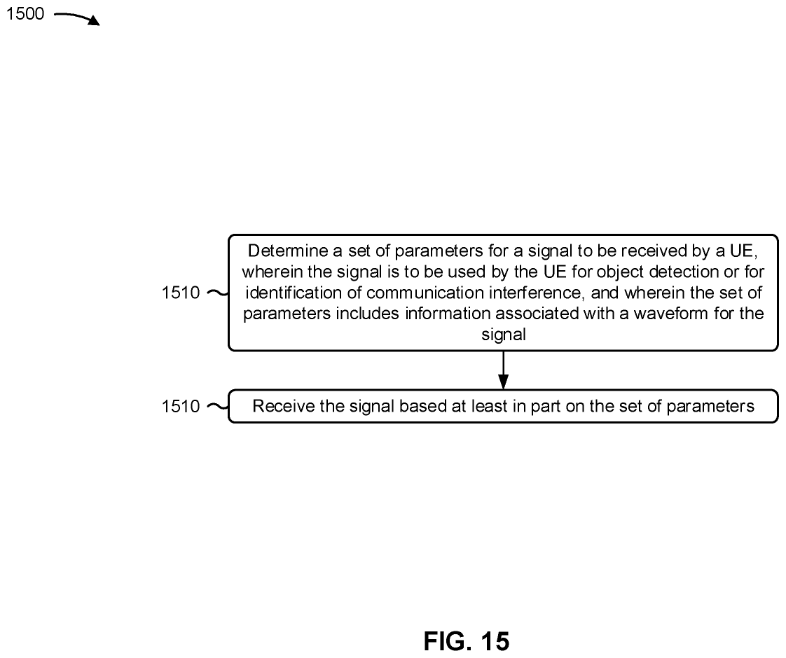

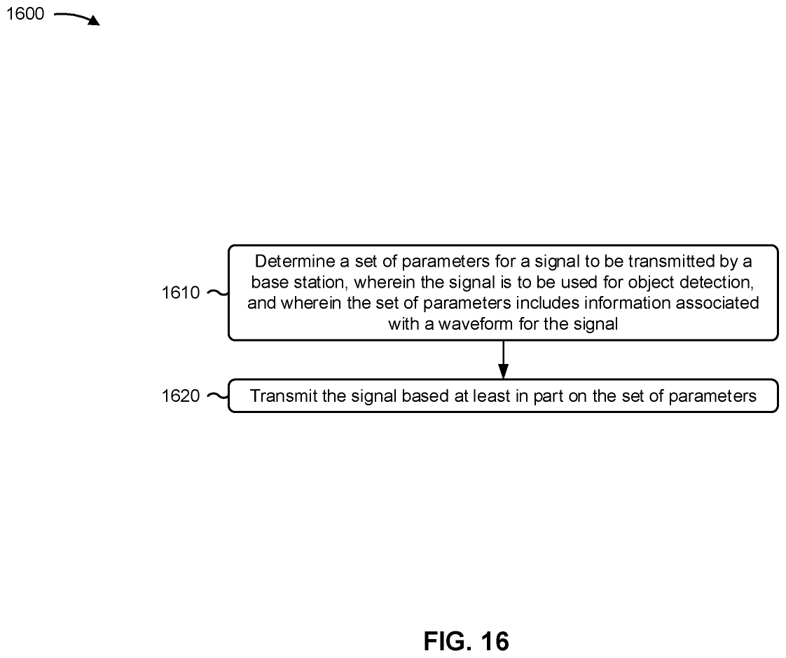

Controller/processor 240 of base station 110, controller/processor 280 of UE 120, and/or any other component(s) of FIG. 2 may perform one or more techniques associated with precoding for joint sensing and communication services, as described in more detail elsewhere herein. For example, controller/processor 240 of base station 110, controller/processor 280 of UE 120, and/or any other component(s) of FIG. 2 may perform or direct operations of, for example, process 700 of FIG. 7, process 800 of FIG. 8, process 900 of FIG. 9, process 1000 of FIG. 10, process 1400 of FIG. 14, process 1500 of FIG. 15, process 1600 of FIG. 16, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, process 900 of FIG. 9, process 1000 of FIG. 10, process 1400 of FIG. 14, process 1500 of FIG. 15, process 1600 of FIG. 16, and/or other processes as described herein. In some aspects, executing instructions may include running the instructions, converting the instructions, compiling the instructions, and/or interpreting the instructions, among other examples.

In some aspects, UE 120 may include means for receiving a configuration or indication, to receive multiple iterations of a sensing signal via multiple slots, that indicates a precoding that is fixed for the multiple slots; means for receiving the multiple iterations of the sensing signal via the multiple slots based at least in part on the precoding; and/or the like. In some aspects, UE 120 may include means for receiving an indication of whether a sensing signal is transmitted using a same precoding as a previous sensing signal or a subsequent sensing signal, means for determining a Doppler estimation associated with an object based at least in part on the sensing signal and the indication of whether the sensing signal is transmitted using the same precoding as the previous sensing signal or the subsequent sensing signal, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, base station 110 may include means for transmitting a configuration or indication, for a UE to receive multiple iterations of a sensing signal via multiple slots, that indicates a precoding that is fixed for the multiple slots; means for transmitting, to the UE, the multiple iterations of the sensing signal via the multiple slots based at least in part on the precoding; and/or the like. In some aspects, base station 110 may include means for transmitting an indication of whether a sensing signal is transmitted to a UE using a same precoding as a previous sensing signal or a subsequent sensing signal, means for receiving an indication of a Doppler estimation associated with an object based at least in part on the sensing signal and the indication of whether the sensing signal is transmitted using the same precoding as the previous sensing signal or the subsequent sensing signal, and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

In some aspects, a receiver, such as a UE 120 or a base station 110, may include means for determining that capability information associated with the receiver is to be transmitted, the capability information indicating one or more sensing signal receiving schemes supported by the receiver; means for transmitting the capability information based at least in part on determining that the capability information is to be transmitted; and/or the like. In some aspects, when the receiver includes a UE 120, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like. In some aspects, when the sensing signal receiver includes a base station 110, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

In some aspects, a receiver, such as a UE 120 or a base station 110, may include means for determining a set of parameters for a signal to be received by the receiver, wherein the signal is to be used by the receiver for object detection or for identification of communication interference, and wherein the set of parameters includes information associated with a waveform for the signal; means for receiving the signal based at least in part on the set of parameters; and/or the like. In some aspects, when the receiver includes a UE 120, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like. In some aspects, when the sensing signal receiver includes a base station 110, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

In some aspects, a transmitter, such as a UE 120 or a base station 110, may include means for determining a set of parameters for a signal to be transmitted by the transmitter, wherein the signal is to be used for object detection, and wherein the set of parameters includes information associated with a waveform for the signal; means for transmitting the signal based at least in part on the set of parameters; and/or the like. In some aspects, when the transmitter includes a UE 120, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like. In some aspects, when the sensing signal transmitter includes a base station 110, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

Some wireless networks may use nodes, such as base stations, to jointly perform sensing services and communication services (e.g., joint SensComm services). The sensing services may include object detection that may be used, for example, to improve the communication services or to improve other services. For example, a UE that receives a sensing signal (e.g., a target detection signal, an object detection signal, a radio detection and ranging (radar) signal, and/or the like) may use the sensing signal to detect objects for services such as assisted driving and/or steering of a vehicle (e.g., to avoid collisions).

Jointly performing sensing services and communication services may support a synergistic design of communications systems and sensing systems (e.g., object detection systems, radar systems, and/or the like) that may use a common spectrum and/or common components. However, sensing signals and communication signals may have different characteristics, which may cause difficulty for managing interference between the sensing signals and the communication signals. For example, communication signals may use OFDM waveforms, and sensing signals may use impulsive signals, frequency-modulated continuous waveforms (FMCW), phase-modulated continuous waveforms (PMCW), and/or the like.

Differences in characteristics of sensing services and communication services may cause difficulty for managing interference between the sensing signals and the communication signals and/or to maintain integrity of the sensing service and/or the communication service. For example, precoding for a communication signal may be adjusted slot-by-slot to improve a signal-to-interference-plus-noise ratio (SINR). Sensing services may be improved by maintaining a constant precoding for transmissions of sensing signals over multiple slots. For example, maintaining a constant precoding for multiple slots may improve resolution of object detection. In some examples, only signals having a same precoding may be coherently used for Doppler estimation, and coherent Doppler estimation may require sensing signals transmitted for a duration that is longer than a slot of the communication signals.

Using time division multiplexing (TDM) and/or frequency division multiplexing (FDM) to transmit the communication signals and the sensing signals may reduce interference between the communication signals and the sensing signals. However, using TDM may lower Doppler resolution of the one or more sensing signals and may cause scheduling restrictions for the one or more communication signals (e.g., to avoid simultaneous transmissions). Similarly, using FDM may cause scheduling restrictions for the one or more communication signals (e.g., to avoid using same or related frequencies) and/or may degrade range resolution of the one or more sensing signals.

Although using space division duplexing (SDM) may cause difficulty for managing interference between the sensing signals and the communication signals and/or to maintain integrity of the sensing service and/or the communication service, using SDM may allow a transmitting node to be spatially selective, to transmit the one or more communication signals and the one or more sensing signals using different beams to reduce interference without lowering Doppler resolution of the one or more sensing signals, degrading range resolution, and/or introducing scheduling restrictions as described when using FDM or SDM.

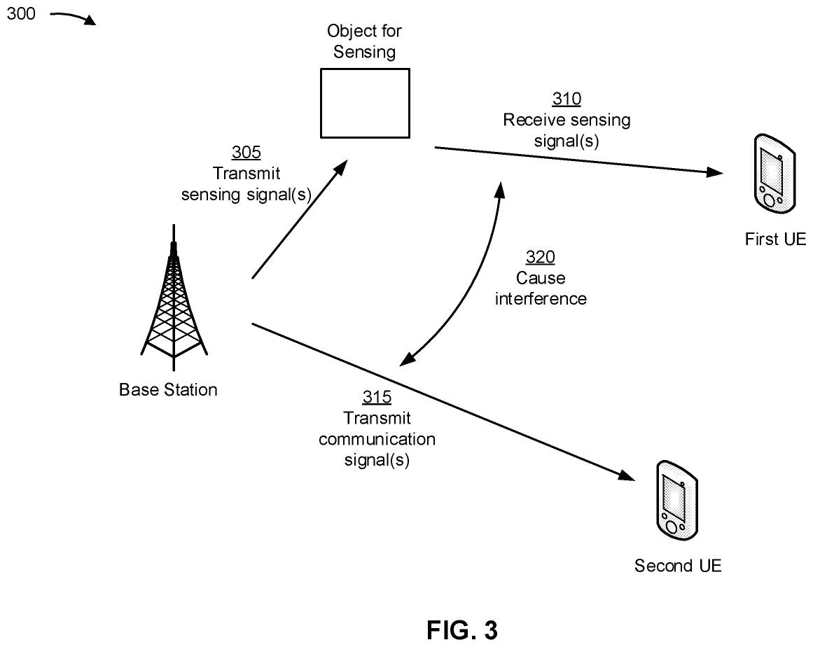

FIG. 3 is a diagram illustrating an example 300 of SDM sensing signals and communication signals, in accordance with the present disclosure. As shown in FIG. 3, a base station may transmit signals for reception by a first UE, a second UE, and/or the like. The base station, the first UE, and the second UE may be part of a wireless network.

As shown by reference number 305, the base station may transmit one or more sensing signals for reception by the first UE. The one or more sensing signals may be used to detect an object based at least in part on the one or more signals interacting with the object between transmission of the one or more signals by the base station and reception of the one or more signals by the first UE. For example, the object may cause reflection, refraction, a Doppler effect, and/or the like to the one or more signals.

As shown by reference number 310, the base station may transmit one or more communication signals to the second UE. For example, the base station may transmit one or more physical downlink control channel (PDCCH) communications, physical downlink shared channel (PDSCH) communications, reference signals, and/or the like.

As shown by reference number 315, the one or more sensing signals may cause interference with the one or more communication signals, and/or the one or more communication signals may cause interference with the one or more sensing signals.

As indicated above, FIG. 3 is provided as an example. Other examples may differ from what is described with regard to FIG. 3.

As described above, a node (e.g., a base station) that jointly performs sensing services and communication services using SDM may provide advantages over TDM and FDM, such as improved Doppler resolution, range resolution, and scheduling. However, a node using SDM may have difficulty managing interference between sensing signals and communication signals based at least in part on, for example, different characteristics of the sensing signals and the communication signals. For example, the node may transmit communication signals that may be improved by modifying precoding slot-by-slot. However, modifying the precoding slot-by-slot may degrade resolution of object detection and/or Doppler detection for a UE that is using a sensing service.

As described herein, a base station (e.g., a node that transmits signals associated with a communication service and a sensing service) may provide an indication of precoding, relative to one or more previous sensing signals and/or one or more subsequent sensing signals, for a sensing signal. In some aspects, the UE may receive an indication that precoding is fixed for multiple slots (e.g., based at least in part on the sensing service having a higher priority than the communication service). In some aspects, the UE may receive an indication of whether a sensing signal is transmitted using a same precoding as a previous sensing signal or a subsequent sensing signal. In this way, the UE may use sensing signals that use a same precoding to perform sensing (e.g., object detection). Based at least in part on using sensing signals that use the same precoding to perform sensing, the UE may avoid or reduce resolution degradation of object detection and/or degradation of Doppler detection.

FIG. 4 is a diagram illustrating an example 400 associated with precoding for joint sensing and communication services, in accordance with the present disclosure. As shown in FIG. 4, a base station (e.g., base station 110) may communicate with a UE (e.g., UE 120). The base station and the UE may be part of a wireless network (e.g., wireless network 100). In some aspects, the UE may be configured to use one or more sensing signals from the base station to support a sensing service. The base station may also support a communication service.

As shown by reference number 405, the base station may transmit, and the UE may receive, configuration information. In some aspects, the UE may receive the configuration information from another device (e.g., from another base station, another UE, and/or the like), from a specification of a communication standard, and/or the like. In some aspects, the UE may receive the configuration information via one or more of radio resource control (RRC) signaling, medium access control (MAC) signaling (e.g., MAC control elements (MAC CEs)), and/or the like. In some aspects, the configuration information may include an indication of one or more configuration parameters (e.g., already known to the UE) for selection by the UE, explicit configuration information for the UE to use to configure the UE, and/or the like.

In some aspects, the configuration information may indicate that the UE is to receive an indication of a configuration or indication that indicates a precoding that is fixed for multiple slots. The configuration information may indicate that the UE is to use multiple iterations of a sensing signal for the multiple slots to determine one or more object detection parameters. For example, the configuration information may indicate that the UE is to use the multiple iterations of the sensing signal to determine a Doppler estimation and/or a location of an object.

As shown by reference number 410, the UE may configure the UE for communicating with the base station and/or for using the sensing service. In some aspects, the UE may configure the UE based at least in part on the configuration information. In some aspects, the UE may be configured to perform one or more operations described herein.

As shown by reference number 415, the base station may transmit, and the UE may receive, an indication and/or configuration information that indicates a precoding that is fixed for multiple slots. In some aspects, the indication and/or configuration information may indicate that the base station is to transmit one or more iterations of the sensing signal via the multiple slots. In some aspects, the UE may receive the indication and/or configuration information via one or more of downlink control information (DCI), one or more MAC CEs, or RRC signaling. In some aspects, the indication and/or configuration information may include a semi-persistent scheduling (SPS) grant. In some aspects, the sensing signal may be associated with a waveform that includes a signal transmitted via an ultra-wide bandwidth, an impulsive signal, a signal transmitted using FMCW, a signal transmitted using PMCW, and/or the like.

In some aspects, the indication and/or configuration information may indicate to receive multiple iterations of one or more additional sensing signals via the multiple slots using one or more additional precodings that are fixed for the multiple slots. In some aspects, an additional indication and/or additional configuration information may indicate to receive multiple iterations of one or more additional sensing signals via the multiple slots using one or more additional precodings that are fixed for the multiple slots. A respective additional sensing signal may have a fixed respective precoding for the multiple slots. In some aspects, the additional precoding may be time division duplexed with the sensing signal within the multiple slots. In some aspects, the sensing signal and the one or more additional sensing signals may be received as a sweeping process in which the UE may receive the sensing signal and the one or more additional sensing signals sequentially during the multiple slots.

As shown by reference number 420, the base station may transmit, and the UE may receive, multiple iterations of the sensing signal based at least in part on the indication and/or configuration information. The UE may receive the one or more iterations of the sensing signal based at least in part on applying the precoding. In some aspects, the UE may also receive multiple iterations of the additional sensing signals based at least in part on the indication and/or configuration information or the additional indication and/or additional configuration information.

As shown by reference number 425, the UE may determine a Doppler estimation and/or a location of an object based at least in part on the sensing signal. For example, the UE may determine the Doppler estimation and/or the location of the object based at least in part on receiving the multiple iterations of the sensing signal via the multiple slots and/or receiving the multiple iterations of the additional sensing signals via the multiple slots. In some aspects, the UE may use the Doppler estimation and/or the location of the object as input for an operation such as driving and/or steering a vehicle, selecting a beam for communicating with the base station or wireless communication device, performing a mapping operation, and/or the like.

As shown by reference number 430, the UE may transmit, and the base station may receive, an indication of the Doppler estimation and/or the location of the object. In some aspects, the UE may transmit the indication using one or more of a MAC CE, a physical uplink control channel (PUCCH) message, a channel state information (CSI) report, an enhanced CSI report, and/or the like.

Based at least in part on using sensing signals over multiple slots that use the same precoding to perform sensing, the UE may use the sensing signals over the multiple slots to determine one or more object detection parameters, and may avoid or reduce resolution degradation of object detection and/or degradation of Doppler detection.

As indicated above, FIG. 4 is provided as an example. Other examples may differ from what is described with regard to FIG. 4.

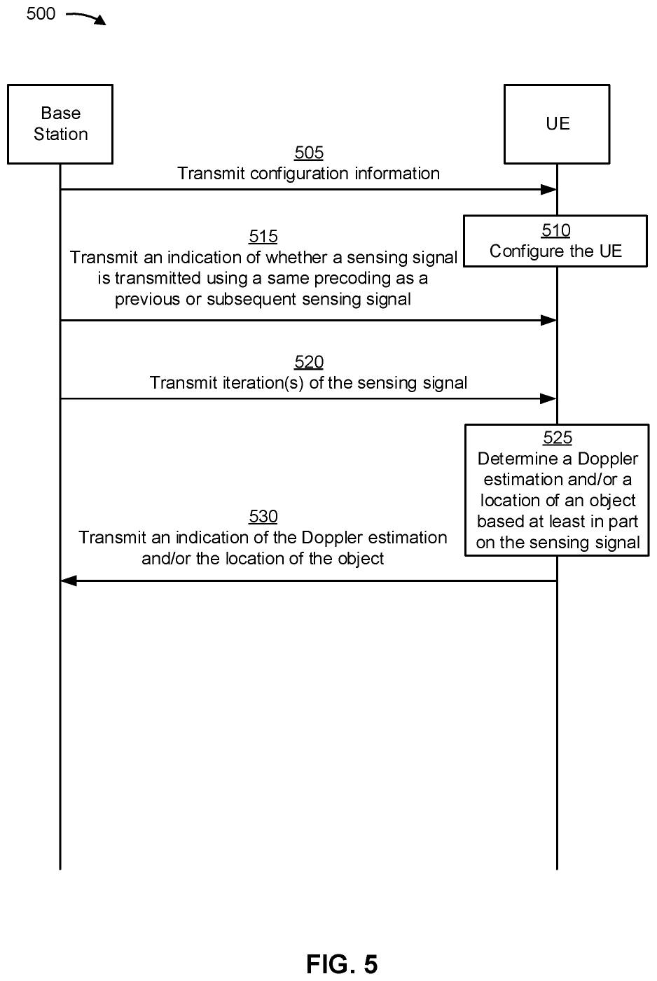

FIG. 5 is a diagram illustrating an example 500 associated with precoding for joint sensing and communication services, in accordance with the present disclosure. As shown in FIG. 5, a base station (e.g., base station 110) may communicate with a UE (e.g., UE 120). The base station and the UE may be part of a wireless network (e.g., wireless network 100). In some aspects, the UE may be configured to use one or more sensing signals from the base station to support a sensing service. The base station may also support a communication service.

As shown by reference number 505, the base station may transmit, and the UE may receive, configuration information. In some aspects, the UE may receive the configuration information from another device (e.g., from another base station, another UE, and/or the like), from a specification of a communication standard, and/or the like. In some aspects, the UE may receive the configuration information via one or more of RRC signaling, MAC signaling (e.g., MAC CEs), and/or the like. In some aspects, the configuration information may include an indication of one or more configuration parameters (e.g., already known to the UE) for selection by the UE, explicit configuration information for the UE to use to configure the UE, and/or the like.

In some aspects, the configuration information may indicate that the UE is to receive an indication of whether a sensing signal is transmitted using a same precoding as a previous sensing signal or a subsequent sensing signal. In some aspects, the indication may identify one or more previous sensing signals and/or one or more subsequent sensing signals that use the same precoding. The configuration information may indicate that the UE is to use multiple iterations of a sensing signal for the multiple slots to determine one or more object detection parameters. For example, the configuration information may indicate that the UE is to use the multiple iterations of the sensing signal to determine a Doppler estimation and/or a location of an object.

As shown by reference number 510, the UE may configure the UE for communicating with the base station and/or for using the sensing service. In some aspects, the UE may configure the UE based at least in part on the configuration information. In some aspects, the UE may be configured to perform one or more operations described herein.

As shown by reference number 515, the base station may transmit, and the UE may receive, an indication of whether the sensing signal is transmitted using the same precoding as the previous sensing signal or the subsequent sensing signal. In some aspects, the indication of whether the sensing signal is transmitted using the same precoding as the previous sensing signal or the subsequent sensing signal may indicate that the base station has already transmitted one or more sensing signals and/or will transmit one or more sensing signals using the same precoding.

In some aspects, the indication of whether the sensing signal is transmitted using the same precoding as the previous sensing signal or the subsequent sensing signal may include an indication of a number of consecutive previous sensing signals transmitted using the same precoding, an indication of a number of consecutive subsequent sensing signals to be transmitted using the same precoding, and/or the like.

In some aspects, the indication may include an identification of the previous sensing signal that used the same precoding and/or identification of the subsequent sensing signal that is to be transmitted using the same precoding. The identification may include an index (e.g., a slot index) associated with the previous sensing signal or the subsequent sensing signal.

In some aspects, the UE may receive the indication of whether the sensing signal is transmitted using the same precoding as the previous sensing signal or the subsequent sensing signal before receiving the sensing signal, simultaneously with receiving the sensing signal, and/or after receiving the sensing signal.

In some aspects, the UE may receive the indication of whether the sensing signal is transmitted using the same precoding as the previous sensing signal or the subsequent sensing signal via one or more of DCI (e.g., a dynamic resource grant), one or more MAC CEs (e.g., a dynamic indication), or RRC signaling (e.g. a configured grant).

As shown by reference number 520, the base station may transmit, and the UE may receive, one or more iterations of the sensing signal based at least in part on a resource grant. The UE may receive the one or more iterations of the sensing signal based at least in part on applying an indicated precoding. The UE may determine the indicated precoding based at least in part on the indication of whether the sensing signal is transmitted using the same precoding as the previous sensing signal.

As shown by reference number 525, the UE may determine a Doppler estimation and/or a location of an object based at least in part on the sensing signal. For example, the UE may determine the Doppler estimation and/or the location of the object based at least in part on receiving the multiple iterations of the sensing signal via multiple slots, as indicated via the indication of whether the sensing signal is transmitted using the same precoding as the previous sensing signal or the subsequent sensing signal. In some aspects, the UE may use the Doppler estimation and/or the location of the object as input for an operation such as driving and/or steering a vehicle, selecting a beam for communicating with the base station or wireless communication device, performing a mapping operation, and/or the like.

As shown by reference number 530, the UE may transmit, and the base station may receive, an indication of the Doppler estimation and/or the location of the object. In some aspects, the UE may transmit the indication using one or more of a MAC CE, a physical uplink control channel (PUCCH) message, a CSI report, an enhanced CSI report, and/or the like.

Based at least in part on receiving an indication of multiple sensing signals that use the same precoding to perform sensing, the UE may use the multiple sensing signals to determine one or more object detection parameters, and may avoid or reduce resolution degradation of object detection and/or degradation of Doppler detection.

As indicated above, FIG. 5 is provided as an example. Other examples may differ from what is described with regard to FIG. 5.

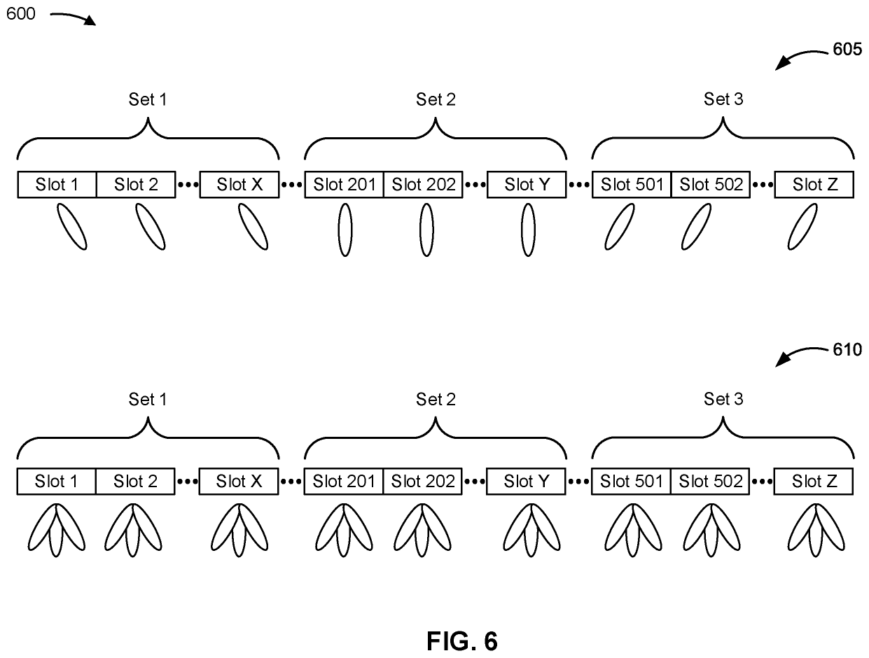

FIG. 6 is a diagram illustrating examples 600 associated with precoding for joint sensing and communication services, in accordance with the present disclosure.

As shown by reference number 605, a base station may transmit, and a UE may receive, sets of sensing signals having a same precoding. For example, set 1 includes multiple iterations of a sensing signal transmitted using a first precoding (e.g., associated with a first beam direction). The UE may receive the set 1 of sensing signals and determine one or more object detection parameters associated with set 1, such as a Doppler estimation and/or a location of an object. Set 2 includes multiple iterations of a sensing signal transmitted using a second precoding (e.g., associated with a second beam direction). The UE may receive the set 2 of sensing signals and determine one or more object detection parameters associated with set 2. Set 3 includes multiple iterations of a sensing signal transmitted using a third precoding (e.g., associated with a third beam direction). The UE may receive the set 3 of sensing signals and determine one or more object detection parameters associated with set 3. In this way, the UE may determine the one or more object detection parameters for different intervals of time using a fixed precoder for each of the intervals.

In some aspects, the UE may receive one or more indications of the configurations shown by reference number 605. For example, the UE may receive an indication for each of the sets of slots in a single indication or in multiple indications. The UE may use the indication of the configurations to configure the UE to receive the sensing signals according to the configurations. In other words, the UE may be configured to receive a periodic sensing signal (e.g., having a waveform that includes a pulse, FMCW, PMCW, OFDM, and/or the like) lasting for multiple slots (e.g., 100 slots) at each instance, and the precoding of the sensing signal may remain fixed during the multiple slots.

As shown by reference number 610, a base station may transmit, and a UE may receive, sets of multiple sensing signals having corresponding precodings. For example, set 1 includes multiple iterations of a first sensing signal transmitted using a first precoding (e.g., associated with a first beam direction), multiple iterations of a second sensing signal transmitted using a second precoding (e.g., associated with a second beam direction), and multiple iterations of a third sensing signal transmitted using a third precoding (e.g., associated with a third beam direction). In some aspects, the base station may indicate to change precoding for one or more of the sensing signals between set 1, set 2, and/or set 3. For example, the base station may change precoding for each of the sensing signals between sets, for none of the sensing signals between sets, or for some of the sensing signals between sets.

In some aspects, the UE may receive one or more indications of the configurations shown by reference number 610. For example, the UE may receive an indication for each of the sets of slots in a single indication or in multiple indications. The UE may use the indication of the configurations to configure the UE to receive the sensing signals according to the configurations. In other words, the UE may be configured to monitor multiple sensing signals having different precodings at each instance, with the precodings of respective signals staying the same across multiple instances.

FIG. 7 is a diagram illustrating an example process 700 performed, for example, by a UE, in accordance with the present disclosure. Example process 700 is an example where the UE (e.g., UE 120 and/or the like) performs operations associated with precoding for joint sensing and communication services.

As shown in FIG. 7, in some aspects, process 700 may include receiving a configuration or indication, to receive multiple iterations of a sensing signal via multiple slots, that indicates a precoding that is fixed for the multiple slots (block 710). For example, the UE (e.g., using receive processor 258, controller/processor 280, memory 282, and/or the like) may receive a configuration or indication, to receive multiple iterations of a sensing signal via multiple slots, that indicates a precoding that is fixed for the multiple slots, as described above.

As further shown in FIG. 7, in some aspects, process 700 may include receiving the multiple iterations of the sensing signal via the multiple slots based at least in part on the precoding (block 720). For example, the UE (e.g., using receive processor 258, controller/processor 280, memory 282, and/or the like) may receive the multiple iterations of the sensing signal via the multiple slots based at least in part on the precoding, as described above.

Process 700 may include additional aspects, such as any single aspect or any combination of aspects described below and/or in connection with one or more other processes described elsewhere herein.

In a first aspect, the sensing signal is associated with a waveform that includes one or more of: a signal transmitted via an ultra-wide bandwidth, an impulsive signal, a signal transmitted using a frequency-modulated continuous wave, or a signal transmitted using a time-modulated continuous wave.

In a second aspect, alone or in combination with the first aspect, the configuration or indication includes an SPS grant.

In a third aspect, alone or in combination with one or more of the first and second aspects, the configuration or indication indicates to receive multiple iterations of an additional sensing signal via the multiple slots using an additional precoding that is fixed for the multiple slots, and process 700 further includes receiving the multiple iterations of the additional sensing signal via the multiple slots based at least in part on the additional precoding.

In a fourth aspect, alone or in combination with one or more of the first through third aspects, process 700 includes receiving an additional configuration or indication, to receive multiple iterations of an additional sensing signal via the multiple slots, that indicates an additional precoding that is fixed for the multiple slots; and receiving the multiple iterations of the additional sensing signal via the multiple slots based at least in part on the additional precoding.

In a fifth aspect, alone or in combination with one or more of the first through fourth aspects, process 700 includes determining a Doppler estimation of an object based at least in part on receiving the multiple iterations of the sensing signal via the multiple slots.

In a sixth aspect, alone or in combination with one or more of the first through fifth aspects, process 700 includes transmitting an indication of a Doppler estimation of an object based at least in part on receiving the multiple iterations of the sensing signal via the multiple slots.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a UE, in accordance with the present disclosure. Example process 800 is an example where the UE (e.g., UE 120 and/or the like) performs operations associated with precoding for joint sensing and communication services.

As shown in FIG. 8, in some aspects, process 800 may include receiving an indication of whether a sensing signal is transmitted using a same precoding as a previous sensing signal or a subsequent sensing signal (block 810). For example, the UE (e.g., using receive processor 258, controller/processor 280, memory 282, and/or the like) may receive an indication of whether a sensing signal is transmitted using a same precoding as a previous sensing signal or a subsequent sensing signal, as described above.

As further shown in FIG. 8, in some aspects, process 800 may include determining a Doppler estimation associated with an object based at least in part on the sensing signal and the indication of whether the sensing signal is transmitted using the same precoding as the previous sensing signal or the subsequent sensing signal (block 820). For example, the UE (e.g., using receive processor 258, controller/processor 280, memory 282, and/or the like) may determine a Doppler estimation associated with an object based at least in part on the sensing signal and the indication of whether the sensing signal is transmitted using the same precoding as the previous sensing signal or the subsequent sensing signal, as described above.

Process 800 may include additional aspects, such as any single aspect or any combination of aspects described below and/or in connection with one or more other processes described elsewhere herein.

In a first aspect, receiving the indication of whether the sensing signal is transmitted using the same precoding as the previous sensing signal or the subsequent sensing signal includes receiving the indication via one or more of: DCI, one or more MAC CEs, or RRC signaling.

In a second aspect, alone or in combination with the first aspect, the indication of whether the sensing signal is transmitted using the same precoding as the previous sensing signal or the subsequent sensing signal includes an identification of the previous sensing signal that used the same precoding.

In a third aspect, alone or in combination with one or more of the first and second aspects, receiving the indication of whether the sensing signal is transmitted using the same precoding as the previous sensing signal or the subsequent sensing signal includes receiving the indication before receiving the sensing signal, or receiving the indication after receiving the sensing signal.

In a fourth aspect, alone or in combination with one or more of the first through third aspects, the indication of whether the sensing signal is transmitted using the same precoding as the previous sensing signal or the subsequent sensing signal includes one or more of: an indication of a number of consecutive previous sensing signals transmitted using the same precoding, or an indication of a number of consecutive subsequent sensing signals to be transmitted using the same precoding.

In a fifth aspect, alone or in combination with one or more of the first through fourth aspects, the indication of whether the sensing signal is transmitted using the same precoding as the previous sensing signal or the subsequent sensing signal includes one or more of: an indication of multiple previous sensing signals transmitted using the same precoding, or an indication of multiple subsequent sensing signals to be transmitted using the same precoding.

In a sixth aspect, alone or in combination with one or more of the first through fifth aspects, process 800 includes transmitting an indication of the Doppler estimation associated with the object based at least in part on the sensing signal and the indication of whether the sensing signal is transmitted using the same precoding as the previous sensing signal or the subsequent sensing signal.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with the present disclosure. Example process 900 is an example where the base station (e.g., base station 110 and/or the like) performs operations associated with precoding for joint sensing and communication services.

As shown in FIG. 9, in some aspects, process 900 may include transmitting a configuration or indication, for a UE to receive multiple iterations of a sensing signal via multiple slots, that indicates a precoding that is fixed for the multiple slots (block 910). For example, the base station (e.g., using transmit processor 220, controller/processor 240, memory 242, and/or the like) may transmit a configuration or indication, for a UE to receive multiple iterations of a sensing signal via multiple slots, that indicates a precoding that is fixed for the multiple slots, as described above.

As further shown in FIG. 9, in some aspects, process 900 may include transmitting, to the UE, the multiple iterations of the sensing signal via the multiple slots based at least in part on the precoding (block 920). For example, the base station (e.g., using transmit processor 220, controller/processor 240, memory 242, and/or the like) may transmit, to the UE, the multiple iterations of the sensing signal via the multiple slots based at least in part on the precoding, as described above.

Process 900 may include additional aspects, such as any single aspect or any combination of aspects described below and/or in connection with one or more other processes described elsewhere herein.

In a first aspect, the sensing signal is associated with a waveform that includes one or more of: a signal transmitted via an ultra-wide bandwidth, an impulsive signal, a signal transmitted using a frequency-modulated continuous wave, or a signal transmitted using a time-modulated continuous wave.

In a second aspect, alone or in combination with the first aspect, the configuration or indication includes a SPS grant.

In a third aspect, alone or in combination with one or more of the first and second aspects, the configuration or indication indicates for the UE to receive multiple iterations of an additional sensing signal via the multiple slots using an additional precoding that is fixed for the multiple slots, and process 900 further includes transmitting the multiple iterations of the additional sensing signal via the multiple slots based at least in part on the additional precoding.

In a fourth aspect, alone or in combination with one or more of the first through third aspects, process 900 includes receiving an indication of a Doppler estimation of an object based at least in part on the multiple iterations of the sensing signal.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a base station, in accordance with the present disclosure. Example process 1000 is an example where the base station (e.g., base station 110 and/or the like) performs operations associated with precoding for joint sensing and communication services.

As shown in FIG. 10, in some aspects, process 1000 may include transmitting an indication of whether a sensing signal is transmitted to a UE using a same precoding as a previous sensing signal or a subsequent sensing signal (block 1010). For example, the base station (e.g., using transmit processor 220, controller/processor 240, memory 242, and/or the like) may transmit an indication of whether a sensing signal is transmitted to a UE using a same precoding as a previous sensing signal or a subsequent sensing signal, as described above.

As further shown in FIG. 10, in some aspects, process 1000 may include receiving an indication of a Doppler estimation associated with an object based at least in part on the sensing signal and the indication of whether the sensing signal is transmitted using the same precoding as the previous sensing signal or the subsequent sensing signal (block 1020). For example, the base station (e.g., using receive processor 238, controller/processor 240, memory 242, and/or the like) may receive an indication of a Doppler estimation associated with an object based at least in part on the sensing signal and the indication of whether the sensing signal is transmitted using the same precoding as the previous sensing signal or the subsequent sensing signal, as described above.

Process 1000 may include additional aspects, such as any single aspect or any combination of aspects described below and/or in connection with one or more other processes described elsewhere herein.

In a first aspect, transmitting the indication of whether the sensing signal is transmitted to the UE using the same precoding as the previous sensing signal or the subsequent sensing signal includes transmitting the indication via one or more of: DCI, one or more MAC CEs, or RRC signaling.

In a second aspect, alone or in combination with the first aspect, the indication of whether the sensing signal is transmitted to the UE using the same precoding as the previous sensing signal or the subsequent sensing signal includes an identification of the previous sensing signal that used the same precoding.

In a third aspect, alone or in combination with one or more of the first and second aspects, transmitting the indication of whether the sensing signal is transmitted to the UE using the same precoding as the previous sensing signal or the subsequent sensing signal includes transmitting the indication before receiving the sensing signal, or transmitting the indication after receiving the sensing signal.

In a fourth aspect, alone or in combination with one or more of the first through third aspects, the indication of whether the sensing signal is transmitted using the same precoding as the previous sensing signal or the subsequent sensing signal includes one or more of: an indication of a number of consecutive previous sensing signals transmitted using the same precoding, or an indication of a number of consecutive subsequent sensing signals to be transmitted using the same precoding.

In a fifth aspect, alone or in combination with one or more of the first through fourth aspects, the indication of whether the sensing signal is transmitted using the same precoding as the previous sensing signal or the subsequent sensing signal includes one or more of: an indication of multiple previous sensing signals transmitted using the same precoding, or an indication of multiple subsequent sensing signals to be transmitted using the same precoding.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

While TDM or FDM techniques can be implemented for SensComm services to avoid interference between sensing and communication services, SDM may be preferred. For example, the use of TDM can lower a Doppler resolution of a sensing service and can introduce scheduling restrictions on communications, while the use of FDM can degrade a range resolution of a sensing service and can also introduce scheduling restrictions on communications.

An architecture for providing a sensing service may provide passive sensing (e.g., single node or multi-node) or active sensing. In a single node passive sensing scheme, a transmitter (e.g., a terrestrial broadcast transmitter, a cellular communications transmitter, and/or the like) may be configured to opportunistically transmit sensing signals, and a receiver may be located remote from the transmitter. In the passive sensing scenario, when the transmitter transmits a sensing signal, the receiver may receive both a line-of-sight (LoS) signal (i.e., the receiver may receive the sensing signal directly from the transmitter without reflection) and one or more signals reflected from one or more objects (i.e., the receiver may receive the sensing signal after reflection of the signal from by the one or more objects). Here, the LoS signal may be used as a reference signal and can be correlated with the one or more reflected signals in association with detecting objects. For example, a delay derived from a correlation maximum associated with a given reflected signal defines an ellipse, and that ellipse describes possible positions of an object relative to the transmitter and the receiver. In a multi-node passive sensing scheme, multiple transmitters each transmit sensing signals for reception by a remote receiver, and the signals may be correlated in association with detecting objects. Notably, the multi-node passive sensing scheme can provide enhanced spatial diversity, improved angular resolution, improved target identifiability (e.g., for low-Doppler targets), and/or the like, as compared to the single node passive sensing scheme. In an active sensing scheme (also referred to as a mono-static sensing scheme), the receiver is co-located with the transmitter (e.g., configured on the same wireless communication device). Here, the transmitter and the receiver may be jointly deployed, separately deployed with information exchange, or separately deployed without information exchange.

In some deployments, spatial interference management techniques may be implemented to avoid interference toward so-called primary signals. Here, the communication signals or the sensing signals can be selected as the primary signals (i.e., a communication service can be selected as a primary service or a sensing service can be selected as the primary service).

In some deployments, sensing signals and communication signals may have different characteristics. For example, in some deployments, communication signals may use OFDM waveforms, and sensing signals may use another type of waveform, such as a pulsed waveform, a FMCW waveform, a PMCW waveform, and/or the like. Alternatively, in some deployments, both sensing signals and communication signals can use the same type of waveform (e.g., sensing signals and communication signals may both use OFDM waveforms, pulsed waveforms, FMCW waveforms, PMCWs, and/or the like).

In operation, a sensing signal is more sensitive to a time domain adjustment of a precoder than a communication signal. With respect to a communication signal, precoding can be adjusted on a slot-by-slot basis. Here, a performance metric for a communication service is an SINR, and adjusting a precoder in the time domain can improve an SINR for a communication service. However, with respect to a sensing signal, precoding may need to remain the same across multiple slots in the time domain. Here, a performance metric for a sensing service is resolution (rather than SINR, although a low SINR can degrade resolution), and time domain observations with the same precoding can be coherently used for Doppler estimation. A coherent duration for a Doppler estimation for an object such as a vehicle or a bicycle is typically significantly longer than a duration of a slot. Therefore, if a precoder were to be adjusted on a slot-by-slot basis (e.g., similar to a communication signal), Doppler estimation would be degraded. Notably, when a sensing service is designated as primary, precoding for a sensing signal may be fixed for multiple slots and a communication signal may be opportunistically transmitted (e.g., based on an interference tolerance of the sensing signal). Conversely, when a communication service is designated as primary, precoding for a sensing signal precoding may be adjusted frequently (e.g., to reduce interference towards a communication signal), while dynamic signaling may be used to indicate sensing signal precoding continuity to allow a receiver of the sensing signal to implement coherent Doppler estimation.

Of note, the sensitivity of sensing signals to time domain precoder adjustment prevents a legacy multi-user (MU) MIMO scheme from being a suitable option for precoder adjustment. According to the legacy MU MIMO scheme, a base station can adjust MU-MIMO precoders to remove MU interference based on reported precoder matrix indicators (PMIs) from different UEs. However, directly reusing this scheme on SDM SensComm degrades sensing performance. For example, if precoders associated with a sensing signal are adjusted in favor of a communication service, illuminating angles are varied in the time domain, which degrades Doppler estimation as described above. Further, SINRs previously reported by a receiver of a sensing signal may be outdated due to mobility (e.g., when pulses with relatively long time domain intervals are used), meaning that additional reporting from sensing signal receivers would be needed. Additionally, communication interference during adjustment of the precoder may lower an SINR and resolution of the sensing signal receiver.

As described herein, a node (e.g., a base station) that jointly performs sensing services and communication services using SDM may provide advantages over TDM and FDM, such as improved Doppler resolution, range resolution, and scheduling. However, a node using SDM may have difficulty managing interference between sensing signals and communication signals based at least in part on, for example, different characteristics of the sensing signals and the communication signals. For example, the node may transmit communication signals that may be improved by modifying precoding slot-by-slot. However, modifying the precoding slot-by-slot may degrade resolution of object detection and/or Doppler estimating for a sensing service.

Some aspects described herein provide techniques and apparatuses for sensing signal configuration and scheduling. In some aspects, the techniques and apparatuses described herein may be implemented to reduce complexity associated with managing interference between sensing signals and communication signals.

For example, in some aspects, a receiver of a sensing signal (e.g., a UE 120) may determine capability information indicating one or more sensing signal receiving schemes supported by the receiver (e.g., whether communication signals can be used for sensing), and may transmit the capability information accordingly.

As another example, in some aspects, a receiver of a sensing signal (e.g., a UE 120) may determine a set of parameters for a signal to be received, where the signal is to be used for object detection or for identification of communication interference and includes information associated with a waveform for the signal. The receiver may then receive the signal based at least in part on the set of parameters.

As another example, in some aspects, a transmitter of a sensing signal (e.g., a UE 120) may determine a set of parameters for a signal to be transmitted, where the signal is to be used for object detection and the set of parameters includes information associated with a waveform for the signal. The transmitter may then transmit the signal based at least in part on the set of parameters.

Notably, the term “sensing signal,” as used herein, may refer to a signal that can be used for target detection, object detection, and/or the like.

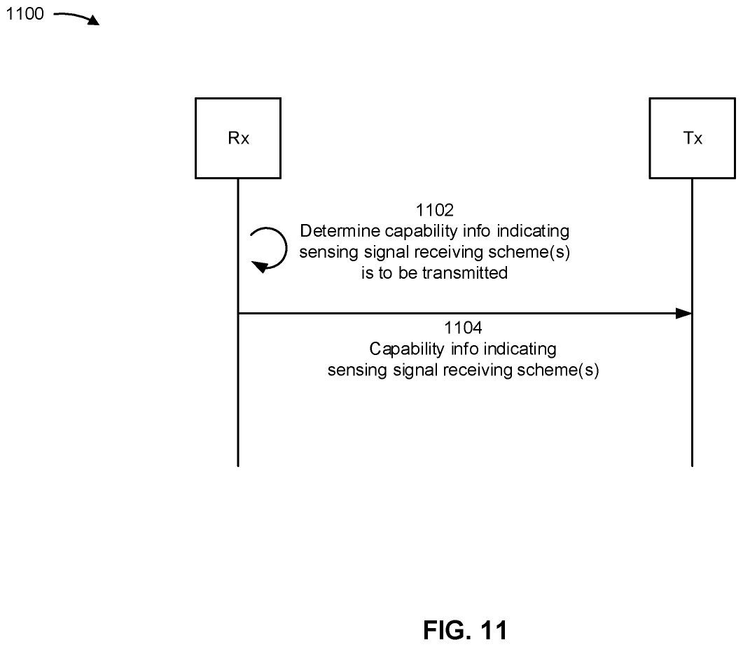

FIG. 11 is a diagram illustrating an example 1100 associated with sensing signal configuration and scheduling, in accordance with the present disclosure. As shown in FIG. 11, example 1100 includes a receiver (e.g., a UE 120, a base station 110, and/or the like) and a transmitter (e.g., a UE 120, a base station 110, and/or the like).

As shown by reference 1102, the receiver may determine that capability information associated with the receiver is to be transmitted. In some aspects, the capability information may include information indicating one or more sensing signal receiving schemes supported by the receiver. For example, the capability information may include information indicating a sensing signal receiving scheme supported (or preferred) by the receiver in association with receiving a sensing signal.

For example, in some aspects, the capability information may indicate that the receiver is capable of using only a sensing-preferred signal for performing sensing. That is, the capability information may indicate that the receiver would only use a sensing-preferred signal, such as a pulsed signal, an FMCW signal, a PMCW signal, or the like, for sensing purposes.

As another example, in some aspects, the capability information may indicate that the receiver is capable of using a communication signal for performing sensing. That is, the capability information may indicate that the receiver could or would use a communication signal (e.g., an OFDM signal) for sensing purposes.

As another example, in some aspects, the capability information may indicate that, at a given time instance, the receiver is capable of using either a sensing-preferred signal or a communication signal for performing sensing. That is, the capability information may indicate that the receiver can only use either a sensing-preferred signal or a communication signal for sensing purposes at a given time domain instance.

As another example, in some aspects, the capability information may indicate that, at a given time instance, the receiver is capable of using both a sensing-preferred signal and a communication signal for performing sensing. That is, the capability information may indicate that the receiver can jointly use both a sensing-preferred signal and a communication signal for sensing purposes at a given time domain instance. Here, the capability information may further indicate that the sensing-preferred signal and the communication signal can include overlapping resources in a frequency domain or, alternatively, may indicate that the sensing-preferred signal and the communication signal cannot include overlapping resources in a frequency domain.

In some aspects, the receiver may determine that the capability information is to be transmitted based at least in part on receiving a request (e.g., from the transmitter). Additionally, or alternatively, the receiver may determine that the capability information is to be transmitted based at least in part on detecting a trigger (e.g., based at least in part on detecting an event that triggers the receiver to transmit the capability information, such as detecting that a SDM SensComm is to be initiated or resumed). Additionally, or alternatively, the receiver may determine that the capability information is to be transmitted based at least in part on a configuration of the receiver (e.g., when the receiver is configured to transmit the capability information automatically on, for example, a periodic basis).

As shown by reference 1104, the receiver may transmit the capability information based at least in part on determining that the capability information is to be transmitted. In some aspects, the receiver may transmit the capability information via a communication link (e.g., a wireless communication link) between the receiver and the transmitter.

In some aspects, a sensing signal may be configured, indicated, transmitted, and/or received based at least in part on the capability information. For example, the receiver and/or the transmitter may determine a set of parameters for a sensing signal based at least in part on the capability information (e.g., including a waveform for the sensing signal), and may receive/transmit the sensing signal accordingly. Additional details regarding configuration and scheduling of a sensing signal are provided below. In some aspects, the capability information indicating one or more sensing signal receiving schemes supported by the receiver may be utilized in association with managing interference in SDM SensComm. For example, a sensing signal may be configured or indicated according to the sensing signal receiving scheme supported by the receiver as part of performing interference management in SDM SensComm.

As indicated above, FIG. 11 is provided as an example. Other examples may differ from what is described with respect to FIG. 11.

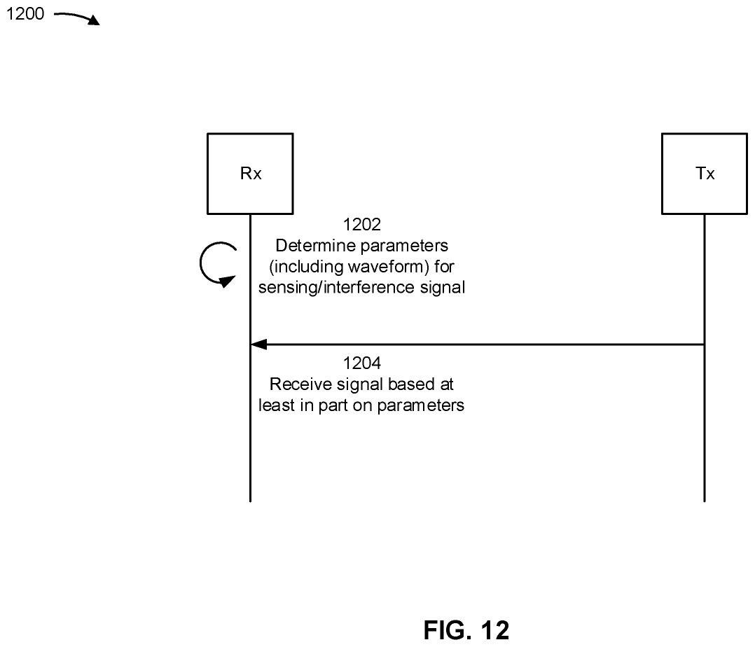

FIG. 12 is a diagram illustrating an example 1200 associated with sensing signal configuration and scheduling, in accordance with the present disclosure. As shown in FIG. 12, example 1200 includes a receiver (e.g., a UE 120, a base station 110, and/or the like) and a transmitter (e.g., a UE 120, a base station 110, and/or the like).

As shown by reference 1202, the receiver may determine a set of parameters for a signal to be received by the receiver. In some aspects, the signal to be received by the receiver may be a signal that is to be used for object detection (i.e., the signal may be a sensing signal). Additionally, or alternatively, the signal to be received by the receiver may be a signal that is to be used for identification of communication interference.

In some aspects, the set of parameters includes information associated with a waveform for the signal. That is, the set of parameters may identify a waveform of the signal to be received by the receiver. The information associated with the waveform for the signal may include information associated with, for example, a duty cycle, a periodicity, an offset, a power control parameter, and/or the like. In some aspects, the information associated with the waveform indicates a waveform for the signal, such as pulse wave, FMCW, PMCW, and/or the like.

In some aspects, the receiver may determine one or more parameters of the set of parameters based at least in part on a preconfiguration of the receiver. That is, in some aspects, one or more parameters for the signal may be predetermined such that the one or more parameters are stored on the receiver. In some aspects, the receiver may determine one or more parameters of the set of parameters based at least in part on a radio resource control (RRC) configuration (e.g., provided by the transmitter). In some aspects, the receiver may determine one or more parameters of the set of parameters based at least in part on an indication received via a medium access control (MAC) control element, downlink control information (DCI), sidelink control information (SCI), and/or the like. In some aspects, the receiver may determine one or more of the set of parameters (e.g., the waveform) based at least in part on capability information indicating one or more sensing signal receiving schemes supported by the receiver.

In some aspects, the set of parameters may include information associated with a time domain resource allocation (TDRA) of the signal. The information associated with the TDRA may include, for example, information indicating a starting symbol of the signal, an ending symbol of the signal, a starting slot of the signal, an ending slot of the signal, a starting mini-slot of the signal, an ending mini-slot of the signal, a starting subframe of the signal, an ending subframe of the signal, a starting frame index of the signal, an ending frame index of the signal, and/or the like.

In some aspects, the set of parameters may include information associated with a frequency domain resource allocation (FDRA) of the signal. The information associated with the FDRA may include, for example, information associated with a contiguous number of physical resource blocks of the signal, a bandwidth part of the signal, a component carrier of the signal, and/or the like.

In some aspects, the set of parameters may include information indicating an origination of the signal. For example, the set of parameters may include information that identifies a type of device that is to transmit the signal (e.g., a base station 110, a UE 120, an integrated access and backhaul (IAB) node configured on a base station 110, and/or the like). As another example, the set of parameters may include information that identifies a type of resource (e.g., downlink, uplink, sidelink, flexible, and/or the like) in which the signal is to be received.

In some aspects, the set of parameters may include SPS information associated with the signal. In some aspects, the SPS information may include, for example, information that identifies a periodicity and an offset of a repetition pattern associated with the semi-persistently scheduled signal.

In some aspects, the set of parameters may include dynamic scheduling information associated with the signal (e.g., scheduling information associated with dynamically scheduling the signal).

In some aspects, the set of parameters may include information indicating a priority of the signal. The information indicating the priority of the signal may include information indicating, for example, that the sensing signal has a lower, higher, or equal priority as compared to another type of signal or channel. The other type of signal or channel may include, for example, a synchronization signal block (SSB), a channel state information reference signal (CSI-RS), a sounding reference signal (SRS), a positioning reference signal (PRS), a phase tracking reference signal (PTRS), a demodulation reference signal (DMRS), a shared channel (e.g., a physical uplink shared channel (PUSCH), a physical downlink shared channel (PDSCH), or a physical sidelink shared channel (PSSCH), among other examples) a control channel (e.g., a physical uplink control channel (PUCCH), a physical downlink control channel (PDCCH), or a physical sidelink control channel (PSCCH), among other examples), among other examples.

As shown by reference 1204, the receiver may receive the signal based at least in part on the set of parameters. For example, since the set of parameters may define the configuration of scheduling of the signal, the receiver may receive the signal based at least in part on the set of parameters. In this way, a signal to be used for object detection and/or for interference identification may be configured and/or scheduled on a receiver in SDM SensComm. In some aspects, such a signal may be used in association with providing interference management in SDM SensComm. In some aspects, the signal may be transmitted by the transmitter after the transmitter determines the set of parameters (e.g., as described below).

As indicated above, FIG. 12 is provided as an example. Other examples may differ from what is described with respect to FIG. 12.

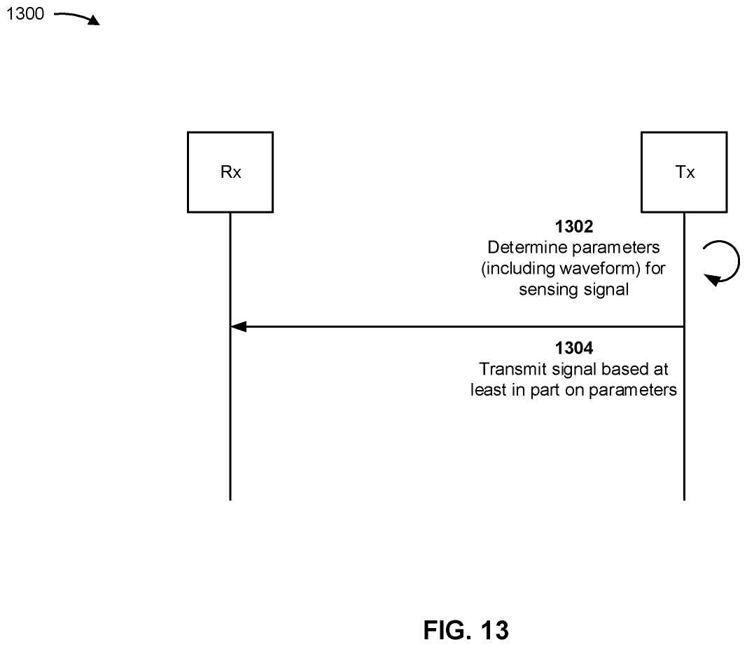

FIG. 13 is a diagram illustrating an example 1300 associated with sensing signal configuration and scheduling, in accordance with the present disclosure. As shown in FIG. 13, example 1300 includes a receiver (e.g., a UE 120, a base station 110, and/or the like) and a transmitter (e.g., a UE 120, a base station 110, and/or the like).

As shown by reference 1302, the transmitter may determine a set of parameters for a signal to be transmitted by the transmitter. In some aspects, the signal to be transmitted by the transmitter may be a signal that is to be used for object detection (i.e., the signal may be a sensing signal).

In some aspects, the set of parameters includes information associated with a waveform for the signal. That is, the set of parameters may identify a waveform of the signal to be transmitted by the transmitter. The information associated with the waveform for the signal may include information associated with, for example, a duty cycle, a periodicity, an offset, a power control parameter, and/or the like. In some aspects, the information associated with the waveform indicates a waveform for the signal, such as pulse wave, FMCW, PMCW, and/or the like.

In some aspects, the transmitter may determine one or more parameters of the set of parameters based at least in part on a preconfiguration of the transmitter. That is, in some aspects, one or more parameters for the signal may be predetermined such that the one or more parameters are stored on the transmitter. In some aspects, the transmitter may determine one or more parameters of the set of parameters based at least in part on an RRC configuration. In some aspects, the transmitter may determine one or more parameters of the set of parameters based at least in part on an indication received via a MAC control element, DCI, SCI, and/or the like. In some aspects, the transmitter may determine one or more of the set of parameters (e.g., the waveform) based at least in part on capability information (e.g., transmitted by the receiver) indicating one or more sensing signal receiving schemes supported by the receiver.

In some aspects, the set of parameters may include information associated with a TDRA of the signal, information associated with an FDRA of the signal, information associated with an origination of the signal, SPS information associated with the signal, dynamic scheduling information associated with the signal, information indicating a priority of the signal, and/or the like, as described above in association with FIG. 12.

As shown by reference 1304, the transmitter may transmit the signal based at least in part on the set of parameters. For example, since the set of parameters may define the configuration of scheduling of the signal, the transmitter may transmit the signal based at least in part on the set of parameters. In this way, a signal to be used for object detection may be configured and/or scheduled on a transmitter in SDM SensComm. In some aspects, such a signal may be used in association with providing interference management in SDM SensComm.

As indicated above, FIG. 13 is provided as an example. Other examples may differ from what is described with respect to FIG. 13.

FIG. 14 is a diagram illustrating an example process 1400 performed, for example, by a receiver, in accordance with the present disclosure. Example process 1400 is an example where the receiver (e.g., a UE 120, a base station 110, and/or the like) performs operations associated with sensing signal configuration and scheduling.

As shown in FIG. 14, in some aspects, process 1400 may include determining that capability information associated with the receiver is to be transmitted, the capability information indicating one or more sensing signal receiving schemes supported by the receiver (block 1410). For example, the receiver (e.g., using receive processor 258, transmit processor 264, controller/processor 280, memory 282, and/or the like when the receiver is a UE 120; using transmit processor 220, receive processor 238, controller/processor 240, memory 242, and/or the like when the receiver is a base station 110) may determine that capability information associated with the receiver is to be transmitted, the capability information indicating one or more sensing signal receiving schemes supported by the receiver, as described above.

As further shown in FIG. 14, in some aspects, process 1400 may include transmitting the capability information based at least in part on determining that the capability information is to be transmitted (block 1420). For example, the receiver (e.g., using transmit processor 264, controller/processor 280, memory 282, and/or the like when the receiver is a UE 120; using transmit processor 220, receive processor 238, controller/processor 240, memory 242, and/or the like when the receiver is a base station 110) may transmit the capability information based at least in part on determining that the capability information is to be transmitted, as described above.

Process 1400 may include additional aspects, such as any single aspect or any combination of aspects described below and/or in connection with one or more other processes described elsewhere herein.

In a first aspect, the capability information indicates that the receiver is capable of using only a sensing-preferred signal for performing sensing.

In a second aspect, alone or in combination with the first aspect, the capability information indicates that the receiver is capable of using a communication signal for performing sensing.

In a third aspect, alone or in combination with one or more of the first and second aspects, the capability information indicates that, at a given time instance, the receiver is capable of using either a sensing-preferred signal or a communication signal for performing sensing.

In a fourth aspect, alone or in combination with one or more of the first through third aspects, the capability information indicates that, at a given time instance, the receiver is capable of using both a sensing-preferred signal and a communication signal for performing sensing.

In a fifth aspect, alone or in combination with one or more of the first through fourth aspects, the capability information indicates that the sensing-preferred signal and the communication signal can include overlapping resources in a frequency domain.

In a sixth aspect, alone or in combination with one or more of the first through fifth aspects, the capability information indicates that the sensing-preferred signal and the communication signal cannot include overlapping resources in a frequency domain.

In a seventh aspect, alone or in combination with one or more of the first through sixth aspects, the capability information indicates that the UE is capable of using a communication signal for performing sensing, the communication signal having an orthogonal frequency division multiplexing waveform or a single-carrier waveform.

In an eighth aspect, alone or in combination with one or more of the first through seventh aspects, the capability information indicates that the UE is capable of using a sensing-preferred signal, the sensing-preferred signal having an orthogonal frequency division multiplexing waveform, a pulsed waveform, a frequency-modulated continuous wave waveform, or a phase-modulated continuous wave waveform.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by a receiver, in accordance with the present disclosure. Example process 1500 is an example where the receiver (e.g., a UE 120, a base station 110, and/or the like) performs operations associated with sensing signal configuration and scheduling.

As shown in FIG. 15, in some aspects, process 1500 may include determining a set of parameters for a signal to be received by the receiver, wherein the signal is to be used by the receiver for object detection or for identification of communication interference, and wherein the set of parameters includes information associated with a waveform for the signal (block 1510). For example, the receiver (e.g., using receive processor 258, transmit processor 264, controller/processor 280, memory 282, and/or the like when the receiver is a UE 120; using transmit processor 220, receive processor 238, controller/processor 240, memory 242, and/or the like when the receiver is a base station 110) may determine a set of parameters for a signal to be received by the receiver, as described above. In some aspects, the signal is to be used by the receiver for object detection or for identification of communication interference. In some aspects, the set of parameters includes information associated with a waveform for the signal.

As further shown in FIG. 15, in some aspects, process 1500 may include receiving the signal based at least in part on the set of parameters (block 1520). For example, the receiver (e.g., using receive processor 258, controller/processor 280, memory 282, and/or the like when the receiver is a UE 120; using receive processor 238, controller/processor 240, memory 242, and/or the like when the receiver is a base station 110) may receive the signal based at least in part on the set of parameters, as described above.

Process 1500 may include additional aspects, such as any single aspect or any combination of aspects described below and/or in connection with one or more other processes described elsewhere herein.

In a first aspect, the information associated with the waveform includes information associated with at least one of: a duty cycle, a periodicity, an offset, or a power control parameter.

In a second aspect, alone or in combination with the first aspect, the information associated with the waveform indicates a pulse wave, a frequency-modulated continuous wave, or a phase-modulated continuous wave.

In a third aspect, alone or in combination with one or more of the first and second aspects, the set of parameters is determined based at least in part on being preconfigured on the receiver.

In a fourth aspect, alone or in combination with one or more of the first through third aspects, the set of parameters is determined based at least in part on a radio resource control configuration.

In a fifth aspect, alone or in combination with one or more of the first through fourth aspects, the set of parameters is determined based at least in part on an indication received via a medium access control control element, downlink control information, or sidelink control information.

In a sixth aspect, alone or in combination with one or more of the first through fifth aspects, the set of parameters includes information associated with a time domain resource allocation (TDRA) of the signal.

In a seventh aspect, alone or in combination with one or more of the first through sixth aspects, the information associated with the TDRA includes information indicating at least one of: a starting symbol, an ending symbol, a starting slot, an ending slot, a starting mini-slot, an ending mini-slot, a starting subframe, an ending subframe, a starting frame index, or an ending frame index.

In an eighth aspect, alone or in combination with one or more of the first through seventh aspects, the set of parameters includes information associated with a frequency domain resource allocation (FDRA) of the signal.

In a ninth aspect, alone or in combination with one or more of the first through eighth aspects, the information associated with the FDRA includes information associated with at least one of: a contiguous number of physical resource blocks, a bandwidth part, or a component carrier.

In a tenth aspect, alone or in combination with one or more of the first through ninth aspects, the set of parameters includes information indicating an origination of the signal.

In an eleventh aspect, alone or in combination with one or more of the first through tenth aspects, the information indicating the origination identifies a type of device that is to transmit the signal.

In a twelfth aspect, alone or in combination with one or more of the first through eleventh aspects, the information indicating the origination identifies a type of resource in which the signal is to be received.

In a thirteenth aspect, alone or in combination with one or more of the first through twelfth aspects, the set of parameters includes SPS information associated with the signal, the SPS information including information that identifies a periodicity and an offset.

In a fourteenth aspect, alone or in combination with one or more of the first through thirteenth aspects, the set of parameters includes dynamic scheduling information associated with the signal.

In a fifteenth aspect, alone or in combination with one or more of the first through fourteenth aspects, the set of parameters includes information indicating a priority of the signal.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram illustrating an example process 1600 performed, for example, by a transmitter, in accordance with the present disclosure. Example process 1600 is an example where the transmitter (e.g., a UE 120, a base station 110, and/or the like) performs operations associated with sensing signal configuration and scheduling.

As shown in FIG. 16, in some aspects, process 1600 may include determining a set of parameters for a signal to be transmitted by the transmitter, wherein the signal is to be used for object detection, and wherein the set of parameters includes information associated with a waveform for the signal (block 1610). For example, the transmitter (e.g., using receive processor 258, transmit processor 264, controller/processor 280, memory 282, and/or the like when the receiver is a UE 120; using transmit processor 220, receive processor 238, controller/processor 240, memory 242, and/or the like when the receiver is a base station 110) may determine a set of parameters for a signal to be transmitted by the transmitter, as described above. In some aspects, the signal is to be used for object detection. In some aspects, the set of parameters includes information associated with a waveform for the signal.

As further shown in FIG. 16, in some aspects, process 1600 may include transmitting the signal based at least in part on the set of parameters (block 1620). For example, the transmitter (e.g., using transmit processor 264, controller/processor 280, memory 282, and/or the like when the receiver is a UE 120; using transmit processor 220, controller/processor 240, memory 242, and/or the like when the receiver is a base station 110) may transmit the signal based at least in part on the set of parameters, as described above.

Process 1600 may include additional aspects, such as any single aspect or any combination of aspects described below and/or in connection with one or more other processes described elsewhere herein.

In a first aspect, the information associated with the waveform includes information associated with at least one of: a duty cycle, a periodicity, an offset, or a power control parameter.

In a second aspect, alone or in combination with the first aspect, the information associated with the waveform indicates a pulse wave, a frequency-modulated continuous wave, or a phase-modulated continuous wave.

In a third aspect, alone or in combination with one or more of the first and second aspects, the set of parameters is determined based at least in part on being preconfigured on the transmitter.

In a fourth aspect, alone or in combination with one or more of the first through third aspects, the set of parameters is determined based at least in part on a radio resource control configuration.

In a fifth aspect, alone or in combination with one or more of the first through fourth aspects, the set of parameters is determined based at least in part on an indication received via a medium access control control element, downlink control information, or sidelink control information.

In a sixth aspect, alone or in combination with one or more of the first through fifth aspects, the set of parameters includes information associated with a TDRA of the signal.

In a seventh aspect, alone or in combination with one or more of the first through sixth aspects, the information associated with the TDRA includes information indicating at least one of: a starting symbol, an ending symbol, a starting slot, an ending slot, a starting mini-slot, an ending mini-slot, a starting subframe, an ending subframe, a starting frame index, or an ending frame index.

In an eighth aspect, alone or in combination with one or more of the first through seventh aspects, the set of parameters includes information associated with an FDRA of the signal.

In a ninth aspect, alone or in combination with one or more of the first through eighth aspects, the information associated with the FDRA includes information associated with at least one of: a contiguous number of physical resource blocks, a bandwidth part, or a component carrier.

In a tenth aspect, alone or in combination with one or more of the first through ninth aspects, the set of parameters includes SPS information associated with the signal, the SPS information including information that identifies a periodicity and an offset.

In an eleventh aspect, alone or in combination with one or more of the first through tenth aspects, the set of parameters includes dynamic scheduling information associated with the signal.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

The following provides an overview of some Aspects of the present disclosure:

Aspect 1: A method of wireless communication performed by a user equipment (UE), comprising: determining that capability information associated with the UE is to be transmitted, the capability information indicating one or more sensing signal receiving schemes supported by the UE; and transmitting the capability information based at least in part on determining that the capability information is to be transmitted.

Aspect 2: The method of Aspect 1, wherein the capability information indicates that the UE is capable of using only a sensing-preferred signal for performing sensing.

Aspect 3: The method of any of Aspects 1-2, wherein the capability information indicates that the UE is capable of using a communication signal for performing sensing.

Aspect 4: The method of any of Aspects 1-3, wherein the capability information indicates that, at a given time instance, the UE is capable of using either a sensing-preferred signal or a communication signal for performing sensing.

Aspect 5: The method of any of Aspects 1-4, wherein the capability information indicates that, at a given time instance, the UE is capable of using both a sensing-preferred signal and a communication signal for performing sensing.

Aspect 6: The method of Aspect 5, wherein the capability information indicates that the sensing-preferred signal and the communication signal can include overlapping resources in a frequency domain.

Aspect 7: The method of Aspect 5, wherein the capability information indicates that the sensing-preferred signal and the communication signal cannot include overlapping resources in a frequency domain.

Aspect 8: The method of any of Aspects 1-7, wherein the capability information indicates that the UE is capable of using a communication signal for performing sensing, the communication signal having an orthogonal frequency division multiplexing waveform or a single-carrier waveform.

Aspect 9: The method of any of Aspects 1-7, wherein the capability information indicates that the UE is capable of using a sensing-preferred signal, the sensing-preferred signal having an orthogonal frequency division multiplexing waveform, a pulsed waveform, a frequency-modulated continuous wave waveform, or a phase-modulated continuous wave waveform.

Aspect 10: A method of wireless communication performed by a user equipment (UE), comprising: determining a set of parameters for a signal to be received by the UE, wherein the signal is to be used by the UE for object detection or for identification of communication interference, and wherein the set of parameters includes information associated with a waveform for the signal; and receiving the signal based at least in part on the set of parameters.

Aspect 11: The method of Aspect 10, wherein the information associated with the waveform includes information associated with at least one of: a duty cycle, a periodicity, an offset, or a power control parameter.

Aspect 12: The method of any of Aspects 10-11, wherein the information associated with the waveform indicates a pulse wave, a frequency-modulated continuous wave, or a phase-modulated continuous wave.

Aspect 13: The method of any of Aspects 10-12, wherein the set of parameters is determined based at least in part on one or more of: the set of parameters being preconfigured on the UE, an indication received via a radio resource control configuration, or an indication received via a medium access control control element, downlink control information, or sidelink control information.

Aspect 14: The method of any of Aspects 10-13, wherein the set of parameters includes information associated with a time domain resource allocation (TDRA) of the signal, and wherein the information associated with the TDRA includes information indicating at least one of: a starting symbol, an ending symbol, a starting slot, an ending slot, a starting mini-slot, an ending mini-slot, a starting subframe, an ending subframe, a starting frame index, or an ending frame index.

Aspect 15: The method of any of Aspects 10-14, wherein the set of parameters includes information associated with a frequency domain resource allocation (FDRA) of the signal, and wherein the information associated with the FDRA includes information associated with at least one of: a contiguous number of physical resource blocks, a bandwidth part, or a component carrier.

Aspect 16: The method of any of Aspects 10-15, wherein the set of parameters includes information indicating an origination of the signal.

Aspect 17: The method of Aspect 16, wherein the information indicating the origination identifies a type of device that is to transmit the signal, or wherein the information indicating the origination identifies a type of resource in which the signal is to be received.

Aspect 18: The method of any of Aspects 10-17, wherein the set of parameters includes one or more of: semi-persistent scheduling (SPS) information associated with the signal, the SPS information including information that identifies a periodicity and an offset, dynamic scheduling information associated with the signal, or information indicating a priority of the signal.

Aspect 19: A method of wireless communication performed by a base station, comprising: determining a set of parameters for a signal to be transmitted by the base station, wherein the signal is to be used for object detection, and wherein the set of parameters includes information associated with a waveform for the signal; and transmitting the signal based at least in part on the set of parameters.

Aspect 20: The method of Aspect 19, wherein the information associated with the waveform includes information associated with at least one of: a duty cycle, a periodicity, an offset, or a power control parameter.

Aspect 21: The method of any of Aspects 19-20, wherein the information associated with the waveform indicates a pulse wave, a frequency-modulated continuous wave, or a phase-modulated continuous wave.

Aspect 22: The method of any of Aspects 19-21, wherein the set of parameters is determined based at least in part on being preconfigured on the base station, wherein the set of parameters is determined based at least in part on a radio resource control configuration, or wherein the set of parameters is determined based at least in part on an indication received via a medium access control control element, downlink control information, or sidelink control information.

Aspect 23: A method of wireless communication performed by a user equipment (UE), comprising: receiving a configuration or indication, to receive multiple iterations of a sensing signal via multiple slots, that indicates a precoding that is fixed for the multiple slots; and receiving the multiple iterations of the sensing signal via the multiple slots based at least in part on the precoding.

Aspect 24: The method of Aspect 23, wherein the sensing signal is associated with a waveform that includes one or more of: a signal transmitted via an ultra-wide bandwidth, an impulsive signal, a signal transmitted using a frequency-modulated continuous wave, or a signal transmitted using a time-modulated continuous wave.

Aspect 25: The method of any of Aspects 23-24, wherein the configuration or indication comprises a semi-persistent scheduling grant.

Aspect 26: The method of any of Aspects 23-25, wherein the configuration or indication indicates to receive multiple iterations of an additional sensing signal via the multiple slots using an additional precoding that is fixed for the multiple slots, and wherein the method further comprises: receiving the multiple iterations of the additional sensing signal via the multiple slots based at least in part on the additional precoding.

Aspect 27: The method of any of Aspects 23-25, further comprising: receiving an additional configuration or additional indication, to receive multiple iterations of an additional sensing signal via the multiple slots, that indicates an additional precoding that is fixed for the multiple slots; and receiving the multiple iterations of the additional sensing signal via the multiple slots based at least in part on the additional precoding.

Aspect 28: A method of wireless communication performed by a user equipment (UE), comprising: receiving an indication of whether a sensing signal is transmitted using a same precoding as a previous sensing signal or a subsequent sensing signal; and receiving the sensing signal.

Aspect 29: The method of Aspect 28, wherein receiving the indication of whether the sensing signal is transmitted using the same precoding as the previous sensing signal or the subsequent sensing signal comprises: receiving the indication via one or more of: downlink control information, one or more medium access control control elements, or radio resource control signaling.

Aspect 30: The method of any of Aspects 28-29, wherein the indication of whether the sensing signal is transmitted using the same precoding as the previous sensing signal or the subsequent sensing signal comprises: an identification of the previous sensing signal that used the same precoding.

Aspect 31: The method of any of Aspects 28-30, wherein receiving the indication of whether the sensing signal is transmitted using the same precoding as the previous sensing signal or the subsequent sensing signal comprises: receiving the indication before receiving the sensing signal, or receiving the indication after receiving the sensing signal.

Aspect 32: The method of any of Aspects 28-31, wherein the indication of whether the sensing signal is transmitted using the same precoding as the previous sensing signal or the subsequent sensing signal comprises one or more of: an indication of a number of consecutive previous sensing signals transmitted using the same precoding, or an indication of a number of consecutive subsequent sensing signals to be transmitted using the same precoding.

Aspect 33: The method of any of Aspects 28-32, wherein the indication of whether the sensing signal is transmitted using the same precoding as the previous sensing signal or the subsequent sensing signal comprises one or more of: an indication of multiple previous sensing signals transmitted using the same precoding, or an indication of multiple subsequent sensing signals to be transmitted using the same precoding.

Aspect 34: A method of wireless communication performed by a base station, comprising: transmitting a configuration or indication, for a user equipment (UE) to receive multiple iterations of a sensing signal via multiple slots, that indicates a precoding that is fixed for the multiple slots; and transmitting, to the UE, the multiple iterations of the sensing signal via the multiple slots based at least in part on the precoding.

Aspect 35: The method of Aspect 34, wherein the sensing signal is associated with a waveform that includes one or more of: a signal transmitted via an ultra-wide bandwidth, an impulsive signal, a signal transmitted using a frequency-modulated continuous wave, or a signal transmitted using a time-modulated continuous wave.

Aspect 36: The method of any of Aspects 34-35, wherein the configuration or indication comprises a semi-persistent scheduling grant.

Aspect 37: The method of any of Aspects 34-36, wherein the configuration or indication indicates for the UE to receive multiple iterations of an additional sensing signal via the multiple slots using an additional precoding that is fixed for the multiple slots, and wherein the method further comprises: transmitting the multiple iterations of the additional sensing signal via the multiple slots based at least in part on the additional precoding.

Aspect 38: A method of wireless communication performed by a base station, comprising: transmitting an indication of whether a sensing signal is transmitted to a user equipment (UE) using a same precoding as a previous sensing signal or a subsequent sensing signal; and transmitting the sensing signal.

Aspect 39: The method of Aspect 38, wherein transmitting the indication of whether the sensing signal is transmitted to the UE using the same precoding as the previous sensing signal or the subsequent sensing signal comprises: transmitting the indication via one or more of: downlink control information, one or more medium access control control elements, or radio resource control signaling.

Aspect 40: The method of any of Aspects 38-39, wherein the indication of whether the sensing signal is transmitted to the UE using the same precoding as the previous sensing signal or the subsequent sensing signal comprises: an identification of the previous sensing signal that used the same precoding.

Aspect 41: The method of any of Aspects 38-40, wherein transmitting the indication of whether the sensing signal is transmitted to the UE using the same precoding as the previous sensing signal or the subsequent sensing signal comprises: transmitting the indication before receiving the sensing signal, or transmitting the indication after receiving the sensing signal.

Aspect 42: The method of any of Aspects 38-41, wherein the indication of whether the sensing signal is transmitted using the same precoding as the previous sensing signal or the subsequent sensing signal comprises one or more of: an indication of a number of consecutive previous sensing signals transmitted using the same precoding, or an indication of a number of consecutive subsequent sensing signals to be transmitted using the same precoding.

Aspect 43: The method of any of Aspects 38-43, wherein the indication of whether the sensing signal is transmitted using the same precoding as the previous sensing signal or the subsequent sensing signal comprises one or more of: an indication of multiple previous sensing signals transmitted using the same precoding, or an indication of multiple subsequent sensing signals to be transmitted using the same precoding.

Aspect 44: An apparatus for wireless communication at a device, comprising a processor; memory coupled with the processor; and instructions stored in the memory and executable by the processor to cause the apparatus to perform the method of one or more Aspects of Aspects 1-43.

Aspect 45: A device for wireless communication, comprising a memory and one or more processors coupled to the memory, the memory and the one or more processors configured to perform the method of one or more Aspects of Aspects 1-43.

Aspect 46: An apparatus for wireless communication, comprising at least one means for performing the method of one or more Aspects of Aspects 1-43.

Aspect 47: A non-transitory computer-readable medium storing code for wireless communication, the code comprising instructions executable by a processor to perform the method of one or more Aspects of Aspects 1-43.

Aspect 48: A non-transitory computer-readable medium storing a set of instructions for wireless communication, the set of instructions comprising one or more instructions that, when executed by one or more processors of a device, cause the device to perform the method of one or more Aspects of Aspects 1-43.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
determine that capability information associated with the UE is to be transmitted, the capability information indicating one or more sensing signal receiving schemes supported by the UE; and
transmit the capability information based at least in part on determining that the capability information is to be transmitted.

2. The UE of claim 1, wherein the capability information indicates that the UE is capable of using only a sensing-preferred signal for performing sensing.

3. The UE of claim 1, wherein the capability information indicates that the UE is capable of using a communication signal for performing sensing.

4. The UE of claim 1, wherein the capability information indicates that, at a given time instance, the UE is capable of using either a sensing-preferred signal or a communication signal for performing sensing.

5. The UE of claim 1, wherein the capability information indicates that, at a given time instance, the UE is capable of using both a sensing-preferred signal and a communication signal for performing sensing.

6. The UE of claim 5, wherein the capability information indicates that the sensing-preferred signal and the communication signal can include overlapping resources in a frequency domain.

7. The UE of claim 5, wherein the capability information indicates that the sensing-preferred signal and the communication signal cannot include overlapping resources in a frequency domain.

8. The UE of claim 1, wherein the capability information indicates that the UE is capable of using a communication signal for performing sensing, the communication signal having an orthogonal frequency division multiplexing waveform or a single-carrier waveform.

9. The UE of claim 1, wherein the capability information indicates that the UE is capable of using a sensing-preferred signal, the sensing-preferred signal having an orthogonal frequency division multiplexing waveform, a pulsed waveform, a frequency-modulated continuous wave waveform, or a phase-modulated continuous wave waveform.

10. A UE for wireless communication, comprising:
a memory; and
one or more processors, coupled to the memory, configured to:
determine a set of parameters for a signal to be received by the UE,
wherein the signal is to be used by the UE for object detection or for identification of communication interference, and
wherein the set of parameters includes information associated with a waveform for the signal; and
receive the signal based at least in part on the set of parameters.

11. The UE of claim 10, wherein the information associated with the waveform includes information associated with at least one of:
a duty cycle,
a periodicity,
an offset, or
a power control parameter.

12. The UE of claim 10, wherein the information associated with the waveform indicates a pulse wave, a frequency-modulated continuous wave, or a phase-modulated continuous wave.

13. The UE of claim 10, wherein the set of parameters is determined based at least in part on one or more of:
the set of parameters being preconfigured on the UE,
an indication received via a radio resource control configuration, or
an indication received via a medium access control control element, downlink control information, or sidelink control information.

14. The UE of claim 10, wherein the set of parameters includes information associated with a time domain resource allocation (TDRA) of the signal, and
wherein the information associated with the TDRA includes information indicating at least one of:
a starting symbol,
an ending symbol,
a starting slot,
an ending slot,
a starting mini-slot,
an ending mini-slot,
a starting subframe,
an ending subframe,
a starting frame index, or
an ending frame index.

15. The UE of claim 10, wherein the set of parameters includes information associated with a frequency domain resource allocation (FDRA) of the signal, and
wherein the information associated with the FDRA includes information associated with at least one of:
a contiguous number of physical resource blocks,
a bandwidth part, or
a component carrier.

16. The UE of claim 10, wherein the set of parameters includes information indicating an origination of the signal.

17. The UE of claim 16, wherein the information indicating the origination identifies a type of device that is to transmit the signal, or
wherein the information indicating the origination identifies a type of resource in which the signal is to be received.

18. The UE of claim 10, wherein the set of parameters includes one or more of:
semi-persistent scheduling (SPS) information associated with the signal, the SPS information including information that identifies a periodicity and an offset,
dynamic scheduling information associated with the signal, or
information indicating a priority of the signal.

19. A method of wireless communication performed by a user equipment (UE), comprising:
determining that capability information associated with the UE is to be transmitted, the capability information indicating one or more sensing signal receiving schemes supported by the UE; and
transmitting the capability information based at least in part on determining that the capability information is to be transmitted.

20. The method of claim 19, wherein the capability information indicates that the UE is capable of using only a sensing-preferred signal for performing sensing.

21. The method of claim 19, wherein the capability information indicates that the UE is capable of using a communication signal for performing sensing.

22. The method of claim 19, wherein the capability information indicates that, at a given time instance, the UE is capable of using either a sensing-preferred signal or a communication signal for performing sensing.

23. The method of claim 19, wherein the capability information indicates that, at a given time instance, the UE is capable of using both a sensing-preferred signal and a communication signal for performing sensing.

24. A method of wireless communication performed by a user equipment (UE), comprising:
determining a set of parameters for a signal to be received by the UE,
wherein the signal is to be used by the UE for object detection or for identification of communication interference, and
wherein the set of parameters includes information associated with a waveform for the signal; and
receiving the signal based at least in part on the set of parameters.

25. The method of claim 24, wherein the information associated with the waveform includes information associated with at least one of:
a duty cycle,
a periodicity,
an offset, or
a power control parameter.

26. The method of claim 24, wherein the information associated with the waveform indicates a pulse wave, a frequency-modulated continuous wave, or a phase-modulated continuous wave.

27. The method of claim 24, wherein the set of parameters is determined based at least in part on one or more of:
the set of parameters being preconfigured on the UE,
an indication received via a radio resource control configuration, or
an indication received via a medium access control control element, downlink control information, or sidelink control information.

28. The method of claim 24, wherein the set of parameters includes information associated with a time domain resource allocation (TDRA) of the signal, and
wherein the information associated with the TDRA includes information indicating at least one of:
a starting symbol,
an ending symbol,
a starting slot,
an ending slot,
a starting mini-slot,
an ending mini-slot,
a starting subframe,
an ending subframe,
a starting frame index, or
an ending frame index.

29. The method of claim 24, wherein the set of parameters includes information associated with a frequency domain resource allocation (FDRA) of the signal, and
wherein the information associated with the FDRA includes information associated with at least one of:
a contiguous number of physical resource blocks,
a bandwidth part, or
a component carrier.

30. The method of claim 24, wherein the set of parameters includes information indicating an origination of the signal.
